(19) United States
(12) Patent Application Publication
(10) Pub. No.: US 2026/0325901 A1
(43) Pub. Date: Oct. 22, 2026

(54) METHOD AND SYSTEM FOR REACTING PER- AND POLYFLUOROALKYL SUBSTANCES (PFAS) USING PULSE SHAPING BURST MODE GAS/LIQUID/PLASMA REACTOR

(71) Applicant: Florida State University Research Foundation, Inc., Tallahassee, FL (US)

(72) Inventors: Bruce R. Locke, Tallahassee, FL (US); Robert Wandell, Tallahassee, FL (US); Radha Krishna Bulusu Raja, Tallahassee, FL (US)

(21) Appl. No.: 19/718,219

(22) Filed: Jun. 24, 2026

Related U.S. Application Data
(63) Continuation-in-part of application No. 18/506,745, filed on Nov. 10, 2023.
(60) Provisional application No. 63/433,615, filed on Dec. 19, 2022.

(51) Int. Cl. A62D 3/19; A62D 101/22

(52) U.S. Cl. CPC A62D 3/19; A62D 2101/22

(57) ABSTRACT

A method of conducting reactions to degrade per- and polyfluoroalkyl substances (PFAS) utilizing a gas/liquid/plasma reactor includes the steps of providing a gas/liquid/plasma reactor, providing a liquid containing PFAS and a gas defining a gas/liquid interface within the gas/liquid/plasma reactor, and charging the PFAS-containing liquid and gas inside the gas/liquid/plasma reactor. The charging includes the application of a voltage to electrodes and thereby to the liquid and gas which includes a series of voltage bursts having an outer burst pulse frequency. The bursts each include a series of voltage pulses having an inner burst pulse frequency. The number of pulses in the voltage burst are N-cycles. The electrodes can be oriented such that a plasma is propagated across the gas/liquid interface when the voltage pulses are applied. A system for conducting reactions to degrade PFAS utilizing a gas/liquid/plasma reactor is also disclosed.

### CROSS-REFERENCE TO RELATED APPLICATIONS

This application is a continuation-in-part of U.S. Ser. No. 18/506,745 filed on Nov. 10, 2023, entitled “PULSE SHAPING BURST MODE GAS/LIQUID/PLASMA REACTOR” which claims priority to U.S. 63/433,615 filed on Dec. 19, 2022, entitled “PULSE SHAPING BURST MODE GAS/PLASMA/LIQUID REACTOR”, the entire disclosure of which incorporated herein by reference.

### STATEMENT REGARDING FEDERALLY SPONSORED RESEARCH AND DEVELOPMENT

This invention was made with government support under Contract No. DE-SC-0021371 and DE-SC0025438 awarded by the U.S. Department of Energy. The government has certain rights in this invention.

### FIELD OF THE INVENTION

The present invention relates generally to methods and systems for the degradation of per- and polyfluoroalkyl substances (PFAS), and more particularly to the degradation of PFAS using plasma reactors.

### BACKGROUND OF THE INVENTION

It has been shown that augmentation of single pulse “shape” (rise-time, pulse width, input voltage) and frequency can influence the energy yield/efficiency and degradation rates of various chemical reactions occurring in a plasma reactor by manipulation of the plasma properties such as plasma gas temperature, electron density, and electron energy. However, optimization of a chemical reactive system with these parameters alone is limited due to the significantly different time scales of the plasma interactions as compared to the time scales of the reactive chemistry and mass transfer between the gas and liquid phases. There is a need for gas/liquid/plasma reactors that can be optimized for improved performance.

Electrical discharge plasma formed in contact with liquid water is of interest for applications in chemical, biomedical, agricultural, electrical, and materials engineering. A wide range of different types of gas-liquid nonthermal plasma reactors that use various power supplies such as DC, AC, microwave, radiofrequency, and pulsed have been developed and tested. Of significant current interest is the utilization of nano-second pulsed discharges to synthesize chemical products such as hydrogen peroxide (H₂O₂) from water and nitrate and nitrite using water with air as a carrier gas. While research on the effects of variation of the pulse properties to control plasma chemistry in general has been conducted, limited work has been reported to modify the waveforms and pulse delivery modes in gas-liquid plasma chemical reactors. Examples in gas-phase plasma chemistry include pulse discharge control for ozone generation, waveform tailoring in plasma etching, waveform tailoring in gas phase spark channels for oxygen atom formation, pulse shape effects on hydroxyl radical, ·OH, production, and pulse shape effects on methane reforming in micro-dielectric barrier discharges. The effects of frequency on plasma properties have been considered, and the role of burst mode operation in plasma jets for bacteria inactivation in wounds has been studied. The effects of residual electrons and plasma conductivity on sequential pulses in a helium plasma jet with nanosecond bursts and the enhancement of atomic hydrogen radical, ·H, by bursts of nanosecond pulses in such plasma jets have been reported. In one of the few reported studies on the effects of the pulse delivery mode in gas-liquid plasma chemistry, it was demonstrated that ·OH enhancement occurred in nitrogen fixation in a burst of three pulses generated over a water surface.

An element of a filamentary plasma channel propagating along a gas-liquid water interface, has been generated by a small, tubular reactor that allows for control of the gas and liquid flows, measurement of the interfacial area and gas and liquid volumes, and determination of transport and plasma properties. The chemical reactions analyzed in this reactor (all for cases of uniform pulse delivery) include H₂O₂ formation, hydrocarbon and organic dyes oxidation, degradation of organic contaminants combined with bioreactors, nitrogen oxides (NO, NO₂, NO₃⁻, NO₂⁻) formation, hydroxyl radical (·OH) generation, degradation of fluorinated compounds, formation of molecular hydrogen (H₂), and formation of aqueous electrons (e⁻_{aq}). Time averaged optical emission spectroscopy (OES) provided average electron density and plasma gas temperature. Time resolved electron density during a single pulse by OES demonstrated the roles of pulse frequency and pulse width on the plasma electrons, which were correlated to the formation of H₂O₂ and the peak electron density correlated to the degradation of fluorinated surfactants (perfluorooctanoic acid—PFOA).

It has been shown that the properties of the single pulse (e.g., rise-time, pulse width, input voltage) with uniformly varied frequency can influence the energy yield/efficiency of various chemical reactions occurring in the reactor by changing the plasma properties (plasma gas temperature, electron density, electron energy). However, optimization of a chemical reactive system with these parameters alone is limited due to the significantly different time scales of the plasma interactions as compared to the time scales of the reactive chemistry and mass transfer between the gas and liquid phase.

Per- and polyfluoroalkyl substances (PFAS) have received much attention due to environmental concerns. These compounds are associated with numerous possible health risks, including a decrease in immunity and an elevated risk of cancer, birth defects, and liver and kidney disease. They are bio-accumulative and toxic to both the environment and human health. Due to a low surface tension and advantageous wetting properties PFAS have become widely used in industry. These uses include many common items such as fire-fighting foams, paints, carpeting, cosmetics, cookware, and clothing. The prevalence of PFAS and the associated health risks make the degradation and elimination of these compounds a very important objective.

PFAS encompass more than 10,000 man-made substances that share a very strong bond between their carbon and fluorine atoms. The carbon-fluorine bond is the shortest and strongest known covalent bond in nature. This bond makes the destruction of these compounds in remediation efforts very difficult. Current approaches include electrochemical oxidation, plasma, photocatalysis, sonolysis, supercritical water oxidation, and thermal degradation/incineration. Improved processes are necessary.

### SUMMARY OF THE INVENTION

A method of conducting reactions utilizing a gas/liquid/plasma reactor, includes the steps of providing a gas/liquid/plasma reactor, providing a liquid and a gas defining a gas/liquid interface within the gas/liquid/plasma reactor, and charging the liquid and gas inside the gas/liquid/plasma reactor. The charging includes the application of a voltage to electrodes and thereby to the liquid and gas which includes a series of voltage bursts having an outer burst pulse frequency. The bursts each include a series of voltage pulses having an inner burst pulse frequency. The electrodes can be oriented such that a plasma is propagated across the gas/liquid interface when the voltage pulses are applied.

The method can further include the steps of injecting a mixture comprising the liquid and the gas into at least one inlet to the gas/liquid/plasma reactor. The inlet can include an inlet electrode. The liquid and the gas inside the inlet are charged with the inlet electrode. The charged liquid and gas are injected into the gas/liquid/plasma reactor. The injecting of the charged liquid and gas generates a continuously flowing liquid film region with the liquid on one or more internal walls of the gas/liquid/plasma reactor and with a gas stream of the gas flowing along the flowing liquid film region. This injection propagates a plasma discharge channel pattern along the interface between the flowing liquid film region and the flowing gas stream inside the gas/liquid/plasma reactor. The liquid, gas, and plasma flow to an outlet comprising an outlet electrode.

The inlet electrode and the outlet electrode can be electrically-conductive capillary tube electrodes. The electrically-conductive capillary inlet tube electrode can have a first internal diameter, the gas/liquid/plasma reactor can be tubular and can have a second internal diameter, and the electrically-conductive capillary outlet tube electrode can have a third diameter. The third internal diameter can be larger than the first internal diameter and smaller than the second internal diameter.

The liquid can be water, and the method can further include the step of dissociating the liquid at the interface with the plasma discharge to form a plurality of dissociation products, and producing hydrogen and/or hydrogen peroxide from the plurality of dissociation products. The hydrogen and/or hydrogen peroxide can be dissolved into the flowing liquid film region.

The liquid water can have a temperature of from greater than 0 to less than 100 degrees Celsius, and the gas/liquid/plasma reactor has a pressure of from approximately 0.1 to 4 bar. The liquid water can have a conductivity of near 1 microSiemens/cm to 50 milliSiemens/cm. The flowing liquid film region can have an annular shape. The inlet and the outlet to the gas/liquid/plasma reactor can include an electrically conductive material.

The electrically conductive material comprises one selected from the group consisting of stainless steel, nickel alloys, chromium alloys, titanium alloys, molybdenum alloys, copper alloys, gold alloys, platinum alloys, zinc alloys, zirconium alloys, and combinations thereof.

The gas can be air. Nitrogen oxides can formed in the gas/liquid/plasma reactor. The gas can be selected from the group consisting of a diatomic gas, a noble gas, and combinations thereof. The diatomic gas can be selected from the group consisting of hydrogen, nitrogen, fluorine, oxygen, iodine, chlorine, bromine, and combinations thereof. The noble gas can be selected from the group consisting of helium, neon, argon, krypton, xenon, radon, and combinations thereof.

The method can further include the step of injecting a target compound with the liquid and the gas, such that the target compound will be reacted in the gas/liquid/plasma reactor. The target compound can be an organic compound that comprises at least one selected from the group consisting of an alkane, an alkene, an alkyne, an aromatic hydrocarbon, and combinations thereof. The alkane can have a structure selected from the group consisting of linear, cyclic, branched, and combinations thereof. The alkene can have a structure selected from the group consisting of linear, cyclic, branched, and combinations thereof. The alkane can be a C1-C20 alkane. The alkane can be at least one selected from the group consisting of methane, ethane, propane, butane, hexane, octane, decane, icosane, isomers thereof, and combinations thereof. The alkene can be a C2-C20 alkene. The alkene can be at least one selected from the group consisting of ethylene, propylene, butane, pentene, hexenes, octenes, decenes, pentadecenes and combinations thereof. The alkyne can be a C2-C20 alkyne. The aromatic hydrocarbon can comprise from 6 to 20 carbon atoms. The aromatic hydrocarbon can be at least one selected from the group consisting of benzene, toluene, ethylbenzene, xylenes, cumene, biphenyl, naphthalene, anthracene, and combinations thereof.

The method can include the step of generating at least one functionalized product from the organic compound. The functionalized product can be at least one selected from the group consisting of an alcohol, a ketone, an aldehyde, an ester, an organic acid, an organic peroxide, and combinations thereof. The functionalized product can be an alcohol including at least one selected from the group consisting of methanol, hexanol, decanol, cyclohexanol, phenol, phenethyl alcohol, benzyl alcohol, and combinations thereof. The functionalized product can be a ketone that includes at least one selected from the group consisting of butanone, hexanone, cyclopentanone, cyclohexanone, propiophenone, benzophenone, and combinations thereof. The functionalized product can be an aldehyde that includes at least one selected from the group consisting of formaldehyde, hexanal, cyclopentanal, cyclohexanal, benzaldehyde, tolualdehyde, and combinations thereof. The functionalized product can be an ester that includes at least one selected from the group consisting of ethyl acetate, ethyl formate, ethyl isovalerate, isobutyl acetate, propyl isobutyrate, ethyl acetate, benzyl acetate, methyl phenylacetate, and combinations thereof. The functionalized product can be an organic acid that includes at least one selected from the group consisting of formic acid, acetic acid, butyric acid, hexanoic acid, cyclohexanecarboxylic acid, benzoic acid, and combinations thereof. The functionalized product can be an organic peroxide or hydroperoxide that includes at least one selected from the group consisting of peracetic acid, hydroperoxyhexane, methyl hydroperoxide, cyclohexane peroxide, benzoyl peroxide, and combinations thereof.

A system for conducting reactions utilizing a gas/liquid/plasma reactor can include a gas/liquid/plasma reactor. A source of a liquid and a gas defining a gas/liquid interface within the gas/liquid/plasma reactor can be provided. Electrodes are provided for charging the liquid and gas inside the gas/liquid/plasma reactor. A voltage source is provided for applying a voltage to the electrodes and thereby to the liquid and gas. The voltage includes a series of voltage bursts having a burst frequency. The bursts each comprise a series of voltage pulses having a pulse frequency. The electrodes can be oriented such that a plasma is propagated across the gas/liquid interface when the voltage pulses are applied.

The plasma discharge can have a nominal outer burst pulse frequency of from 100 Hz to 10 MHz. The plasma discharge can have an inner burst pulse frequency of from about 100 Hz to 10 MHz. The voltage applied to the electrodes can be from 1-50 kV.

The gas/liquid/plasma reactor can include at least one inlet to the gas/liquid/plasma reactor. The inlet can include an inlet electrode, wherein the liquid and the gas are charged inside the inlet by the inlet electrode. The inlet injects the charged liquid and gas into the gas/liquid/plasma reactor. The injecting of the charged liquid and gas generates a continuously flowing liquid film region with the liquid on one or more internal walls of the gas/liquid/plasma reactor and with a gas stream of the gas flowing along the flowing liquid film region. The injecting further propagates a plasma discharge channel pattern along the interface between the flowing liquid film region and the flowing gas stream inside the gas/liquid/plasma reactor. An outlet can include an outlet electrode.

The inlet electrode and the outlet electrode can be electrically-conductive capillary tube electrodes. The electrically-conductive capillary inlet tube electrode has a first internal diameter, the gas/liquid/plasma reactor can be tubular and can have a second internal diameter, and the electrically-conductive capillary outlet tube electrode can have a third diameter. The third internal diameter can be larger than the first internal diameter and smaller than the second internal diameter.

A method of degrading per- and polyfluoroalkyl substances (PFAS) utilizing a gas/liquid/plasma reactor can include the steps of:
providing a gas/liquid/plasma reactor;
providing a PFAS-containing liquid and a gas defining a gas/liquid interface within the gas/liquid/plasma reactor;
charging the PFAS-containing liquid and gas inside the gas/liquid/plasma reactor, the charging comprising the application of a voltage to electrodes and thereby to the PFAS-containing liquid and gas comprising a series of voltage bursts having an outer burst frequency, the voltage bursts each comprising a series of voltage pulses having an inner burst pulse frequency, the number of pulses in the voltage burst are N-cycles, the electrodes being oriented such that a plasma is propagated across the gas/liquid interface when the voltage pulses are applied.

The plasma discharge for PFAS degradation can have an outer burst frequency of from 100 Hz to 20 kHz. The plasma discharge for PFAS degradation can have an inner burst pulse frequency of from about 50 kHz to 2 MHz. The plasma discharge can have a burst period of 0.05 to 2 ms. The plasma discharge can have a N cycle of from 1 to 100.

A gas/liquid/plasma reactor for PFAS degradation can comprise at least one inlet to the gas/liquid/plasma reactor, the inlet comprising an inlet electrode, wherein a PFAS-containing liquid and the gas are charged inside the inlet by the inlet electrode; the inlet injecting the charged PFAS-containing liquid and gas into the gas/liquid/plasma reactor, the injecting of the charged PFAS-containing liquid and gas generating a continuously flowing liquid film region with the liquid on one or more internal walls of the gas/liquid/plasma reactor and with a gas stream of the gas flowing along the flowing liquid film region;
the injecting further propagating a plasma discharge channel pattern along the interface between the flowing liquid film region and the flowing gas stream inside the gas/liquid/plasma reactor; and,
an outlet comprising an outlet electrode.

The inlet electrode and the outlet electrode can be electrically-conductive capillary tube electrodes. The electrically-conductive capillary inlet tube electrode can have a first internal diameter, the gas/liquid/plasma reactor can be tubular and can have a second internal diameter, the electrically-conductive capillary outlet tube electrode can have a third diameter, and wherein the third internal diameter is larger than the first internal diameter and smaller than the second internal diameter.

### BRIEF DESCRIPTION OF THE DRAWINGS

There are shown in the drawings embodiments that are presently preferred it being understood that the invention is not limited to the arrangements and instrumentalities shown, wherein:

FIG. 1 is a schematic diagram of a process according to various embodiments.

FIG. 2 shows an illustration of a vertical cross section of the plasma reactor according to various embodiments.

FIG. 3 is a cross section taken along line A-A in FIG. 2.

FIG. 4 is a schematic of voltage/current/power vs time showing a summary of bust mode operation parameters.

FIG. 5 is a schematic of plasma propagating along gas-liquid interface (not to scale).

FIG. 6 is a depiction of time scale estimates or processes in gas-liquid plasma.

FIG. 7 is a plot of H₂ production rate (mol/min) and energy yield with frequency (kHz) in argon and helium plasma with frequency.

FIG. 8 is a schematic diagram depicting H₂ formation during pulses (not shown to scale).

FIG. 9 is a schematic diagram depicting H₂ formation during pulses (not shown to scale).

FIG. 10 is a schematic diagram depicting H₂ formation during pulses with burst (not shown to scale).

FIG. 11 is plot of H₂O₂ production rate (mol/min) and energy yield with frequency (kHz) in argon and helium plasma with frequency.

FIG. 12 is a depiction of H₂O₂ formation during pulses for low frequency case, for region I in FIG. 9 (not shown to scale, no burst.

FIG. 13 is depiction of H₂O₂ formation during pulses for high frequency, for region II in FIG. 9 (not shown to scale, no burst).

FIG. 14 is a depiction of H₂O₂ formation during pulses with burst mode (not shown to scale).

FIG. 15 is a plot of electron density (cm⁻³) with varying uniform pulse frequency (1-60 kHz).

FIG. 16 is a plot of electron density (cm⁻³) varying with outer burst frequency (1-10 kHz) at a constant internal frequency of 100 kHz and 5 N-cycles.

FIG. 17 is an experimental set-up showing gas and liquid feed streams into a quartz cell reactor connected to a nanosecond pulsed power supply.

FIG. 18 is a plot of voltage (kV) and current (A) waveforms for 100 kHz internal frequency (10 μs between pulses in the burst), 1 ms burst period and 10 N-cycles.

FIG. 19A is a plot of total discharge power (W) for methylene blue with uniform frequency; FIG. 19B is a plot of total discharge power (W) for methylene blue for Case I; FIG. 19C is a plot of total discharge power (W) for methylene blue for Case II; FIG. 19D is a plot of total discharge power (W) for methylene blue for Case III.

FIG. 20A is a plot of discharge power (W) vs. internal frequency (kHz) for H₂O₂ Case I; FIG. 20B is a plot of discharge power (W) vs. burst period (ms) for H₂O₂ Case II; FIG. 20C is a plot of discharge power (W) vs. N-cycles for H₂O₂ Case III.

FIG. 21A is a plot of H₂O₂ production rate (mol/s) and energy yields for Case I—variation of inner frequency with constant 1 ms burst period and 5 N-cycles (pulses in a burst); FIG. 21B is a plot of H₂O₂ production rate (mol/s) and energy yields for Case II—variation of burst period (ms) at fixed 5 N-cycles (pulses in a burst) and 100 kHz internal frequency; and FIG. 21C is a plot of H₂O₂ production rate (mol/s) and energy yields for Case III—variation of N-cycles (pulses in a burst) at fixed 1 ms burst period and 100 kHz inner burst frequency.

FIG. 22 is an H₂O₂ production rate (mol/s) vs. discharge power (W) for uniform pulse, varying internal frequency burst, varying burst period, and varying N-cycle burst.

FIG. 23 is a plot of H₂O₂ production per pulse (mol/s) vs energy per pulse (μWs) for all cases; uniform pulse, varying internal frequency burst, varying burst period, and varying N-cycle.

FIG. 24A is a plot of methylene blue decoloration rates (mol/s) vs. overall frequency (kHz) for uniform pulsing; FIG. 24B is a plot of methylene blue decoloration rates (mol/s) for Case I—variation of internal frequency (kHz); FIG. 24C is a plot of methylene blue decoloration rates (mol/s) for Case II—variation of burst period (ms); and FIG. 24D is a plot of methylene blue decoloration rates (mol/s) for Case III—variation of N-cycles.

FIG. 25 is a plot of methylene blue degradation rate (mol/s) vs. power (W) for uniform pulsing and various burst modes.

FIG. 26 is a plot of energy yield (mol/J) vs. power (W) for combined data of all trials for the three flowrates.

FIG. 27 is a plot of decoloration per pulse (mol) vs energy per pulse (μWs) for 15 mL/min MB trials.

FIG. 28 is a plot of decoloration rate (mol/s) vs total number of pulses for 15 mL/min methylene blue trials.

FIG. 29 is a schematic depiction of a reaction mechanism pathway for the formation of H₂O₂ and methylene blue decoloration.

FIG. 30 is a plot of energy per pulse (μWs) and total discharge power (W) vs. uniform pulse frequency (kHz).

FIG. 31 is a plot of energy per burst (μWs) and total discharge power (W) vs. N-cycles.

FIG. 32 is a plot of energy per burst (μWs) and total discharge power (W) vs. inner burst frequency (kHz).

FIG. 33 is a plot of energy per pulse (μWs) and total discharge power (W) vs. outer burst frequency (kHz).

FIG. 34 is a plot of F⁻ production rate (mol/s) and F⁻ energy yield (mol/J) vs. uniform pulse frequency (kHz).

FIG. 35 is a plot of F⁻ production rate (mol/s) and F⁻ energy yield (mol/J) vs. N-cycles.

FIG. 36 is a plot of F⁻ production rate (mol/s) and F⁻ energy yield (mol/J) vs. inner burst frequency (kHz).

FIG. 37 is a plot of F⁻ production rate (mol/s) and F⁻ energy yield (mol/J) vs. outer burst frequency (kHz).

FIG. 38 is a plot of time-scales of burst and the lifetimes of reactive species.

FIG. 39 is a plot of reactive species production with varying N-cycles and internal frequency.

FIG. 40 is a plot of reactive species production with varying N-cycles and internal frequency.

FIG. 41 is a plot of F⁻ production rate (mol/s) vs. total discharge power (W).

### DETAILED DESCRIPTION OF THE INVENTION

A method of conducting reactions utilizing a gas/liquid/plasma reactor, includes the steps of providing a gas/liquid/plasma reactor, providing a liquid and a gas defining a gas/liquid interface within the gas/liquid/plasma reactor, and charging the liquid and gas inside the gas/liquid/plasma reactor. The charging includes the application of a voltage to electrodes and thereby to the liquid and gas which includes a series of voltage bursts having an outer burst pulse frequency. The bursts each include a series of voltage pulses having an inner burst pulse frequency. The electrodes can be oriented such that a plasma is propagated across the gas/liquid interface when the voltage pulses are applied.

The plasma discharge can have an outer burst pulse frequency of from 100 Hz to 10 MHz. The plasma discharge can have an outer burst frequency of 100 Hz, 150 Hz, 200 Hz, 250 Hz, 300 Hz, 350 Hz, 400 Hz, 450 Hz, 500 Hz, 550 Hz, 600 Hz, 650 Hz, 700 Hz, 750 Hz, 800 Hz, 850 Hz, 900 Hz, 950 Hz, 1 kHz, 50 kHz, 100 kHz, 150 kHz, 200 kHz, 250 kHz, 300 kHz, 350 kHz, 400 kHz, 450 kHz, 500 kHz, 550 kHz, 600 kHz, 650 kHz, 700 kHz, 750 kHz, 800 kHz, 850 kHz, 900 kHz, 950 kHz, 1 MHz, 1.5 MHz, 2 MHz, 2.5 MHz, 3 MHz, 3.5 MHz, 4 MHz, 4.5 MHz, 5 MHz, 5.5 MHz, 6 MHz, 6.5 MHz, 7 MHz, 7.5 MHz, 8 MHz, 8.5 MHz, 9 MHz, 9.5 MHz, or 10 MHz. The outer burst frequency can be within a range of any high value and low value selected from these values.

The plasma discharge can have an inner burst pulse frequency of from about 100 Hz to 10 MHz. The plasma discharge can have an inner burst pulse frequency of 100 Hz, 150 Hz, 200 Hz, 250 Hz, 300 Hz, 350 Hz, 400 Hz, 450 Hz, 500 Hz, 550 Hz, 600 Hz, 650 Hz, 700 Hz, 750 Hz, 800 Hz, 850 Hz, 900 Hz, 950 Hz, 1 kHz, 50 kHz, 100 kHz, 150 kHz, 200 kHz, 250 kHz, 300 kHz, 350 kHz, 400 kHz, 450 kHz, 500 kHz, 550 kHz, 600 kHz, 650 kHz, 700 kHz, 750 kHz, 800 kHz, 850 kHz, 900 kHz, 950 kHz, 1 MHz, 1.5 MHz, 2 MHz, 2.5 MHz, 3 MHz, 3.5 MHz, 4 MHz, 4.5 MHz, 5 MHz, 5.5 MHz, 6 MHz, 6.5 MHz, 7 MHz, 7.5 MHz, 8 MHz, 8.5 MHz, 9 MHz, 9.5 MHz, or 10 MHz. The inner burst pulse frequency can be within a range of any high value and low value selected from these values.

The voltage applied to the electrodes can be from 1-50 kV. The voltage applied to the electrodes can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 kV. The voltage applied to the electrodes can be within a range of any high value and low value selected from these values.

The method can further include the steps of injecting a mixture comprising the liquid and the gas into at least one inlet to the gas/liquid/plasma reactor. The inlet can include an inlet electrode. The liquid and the gas inside the inlet are charged with the inlet electrode. The charged liquid and gas are injected into the gas/liquid/plasma reactor. The injecting of the charged liquid and gas generates a continuously flowing liquid film region with the liquid on one or more internal walls of the gas/liquid/plasma reactor and with a gas stream of the gas flowing along the flowing liquid film region. This injection propagates a plasma discharge channel pattern along the interface between the flowing liquid film region and the flowing gas stream inside the gas/liquid/plasma reactor. The liquid, gas, and plasma flow to an outlet comprising an outlet electrode.

The inlet electrode and the outlet electrode can be electrically-conductive capillary tube electrodes. The electrically-conductive capillary inlet tube electrode can have a first internal diameter, the gas/liquid/plasma reactor can be tubular and can have a second internal diameter, and the electrically-conductive capillary outlet tube electrode can have a third diameter. The third internal diameter can be larger than the first internal diameter and smaller than the second internal diameter.

The liquid can be water, and the method can further include the step of dissociating the liquid at the interface with the plasma discharge to form a plurality of dissociation products, and producing hydrogen and/or hydrogen peroxide from the plurality of dissociation products. The hydrogen and/or hydrogen peroxide can be dissolved into the flowing liquid film region.

The flowing of the liquid, gas, plasma, and hydrogen and/or hydrogen peroxide to the electrically conductive outlet capillary tube electrode can further include the step of recovering at least a portion of the hydrogen and/or hydrogen peroxide from the electrically conductive outlet capillary tube electrode. The hydrogen peroxide that is dissolved into the flowing liquid film region can be protected from degradation as the hydrogen peroxide flows through the flowing liquid film region and exits the continuously-flowing gas/liquid/plasma reactor via the electrically conductive outlet capillary.

The liquid such as water can have a temperature of from greater than 0 to less than 100 degrees Celsius. The liquid temperature can be 0.1, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, or 99.9 degrees Celsius, and can be within a range of any high value and low value selected from these values.

The gas/liquid/plasma reactor can have a pressure of from approximately 0.1 to 4 bar. The gas/liquid/plasma reactor can have a pressure of 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9 or 4 bar, and can have a pressure between any high value and low value selected from these values.

The liquid such as water can have a conductivity of near 1 microSiemens/cm to 50 milliSiemens/cm. The liquid can have a conductivity of 1, 2, 3, 4, 5, 6, 7, 8, 9, 10, 20, 30, 40, 50, 60, 70, 80, 90, 100, 150, 200, 250, 300, 350, 400, 450, 500, 550, 600, 650, 700, 750, 800, 850, 900, 950, or 1000 microSiemens/cm, or 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 milliSiemens/cm, and can have a range of conductivities between any high value and low value selected from these values.

The flowing liquid film region can have different shapes. The flowing liquid film region can have an annular shape.

The inlet and the outlet to the gas/liquid/plasma reactor can include an electrically conductive material. The electrically conductive material can include at least one selected from the group consisting of stainless steel, nickel alloys, chromium alloys, titanium alloys, molybdenum alloys, copper alloys, gold alloys, platinum alloys, zinc alloys, zirconium alloys, and combinations thereof.

The gas can be selected from many different gases. The gas can be air. In the case of air, nitrogen oxides can be formed in the gas/liquid/plasma reactor. The gas can be at least one selected from the group consisting of a diatomic gas, a noble gas, and combinations thereof. The diatomic gas can be at least one selected from the group consisting of hydrogen, nitrogen, fluorine, oxygen, iodine, chlorine, bromine, and combinations thereof. The noble gas can be at least one selected from the group consisting of helium, neon, argon, krypton, xenon, radon, and combinations thereof.

The method can further include the step of injecting a target compound with the liquid and the gas, such that the target compound will be reacted in the gas/liquid/plasma reactor. The target compound can be an organic compound that comprises at least one selected from the group consisting of an alkane, an alkene, an alkyne, an aromatic hydrocarbon, and combinations thereof. The alkane can have a structure selected from the group consisting of linear, cyclic, branched, and combinations thereof. The alkene can have a structure selected from the group consisting of linear, cyclic, branched, and combinations thereof. The alkane can be a C₁-C₂₀ alkane. The alkane can be at least one selected from the group consisting of methane, ethane, propane, butane, hexane, octane, decane, icosane, isomers thereof, and combinations thereof. The alkene can be a C₂-C₂₀ alkene. The alkene can be at least one selected from the group consisting of ethylene, propylene, butane, pentene, hexenes, octenes, decenes, pentadecenes and combinations thereof. The alkyne can be a C₂-C₂₀ alkyne. The aromatic hydrocarbon can comprise from 6 to 20 carbon atoms. The aromatic hydrocarbon can be at least one selected from the group consisting of benzene, toluene, ethylbenzene, xylenes, cumene, biphenyl, naphthalene, anthracene, and combinations thereof.

The method can include the step of generating at least one functionalized product from the organic compound. The functionalized product can be at least one selected from the group consisting of an alcohol, a ketone, an aldehyde, an ester, an organic acid, an organic peroxide, and combinations thereof. The functionalized product can be an alcohol including at least one selected from the group consisting of methanol, hexanol, decanol, cyclohexanol, phenol, phenethyl alcohol, benzyl alcohol, and combinations thereof. The functionalized product can be a ketone that includes at least one selected from the group consisting of butanone, hexanone, cyclopentanone, cyclohexanone, propiophenone, benzophenone, and combinations thereof. The functionalized product can be an aldehyde that includes at least one selected from the group consisting of formaldehyde, hexanal, cyclopentanal, cyclohexanal, benzaldehyde, tolualdehyde, and combinations thereof. The functionalized product can be an ester that includes at least one selected from the group consisting of ethyl acetate, ethyl formate, ethyl isovalerate, isobutyl acetate, propyl isobutyrate, ethyl acetate, benzyl acetate, methyl phenylacetate, and combinations thereof. The functionalized product can be an organic acid that includes at least one selected from the group consisting of formic acid, acetic acid, butyric acid, hexanoic acid, cyclohexanecarboxylic acid, benzoic acid, and combinations thereof. The functionalized product can be an organic peroxide or hydroperoxide that includes at least one selected from the group consisting of peracetic acid, hydroperoxyhexane, methyl hydroperoxide, cyclohexane peroxide, benzoyl peroxide, and combinations thereof.

A system for conducting reactions utilizing a gas/liquid/plasma reactor can include a gas/liquid/plasma reactor. A source of a liquid and a gas defining a gas/liquid interface within the gas/liquid/plasma reactor can be provided. Electrodes are provided for charging the liquid and gas inside the gas/liquid/plasma reactor. A voltage source is provided for applying a voltage to the electrodes and thereby to the liquid and gas. The voltage includes a series of voltage bursts having an outer burst pulse frequency. The bursts each comprise a series of voltage pulses having an inner burst pulse frequency. The electrodes can be oriented such that a plasma is propagated across the gas/liquid interface when the voltage pulses are applied.

The plasma discharge can have a nominal outer burst frequency of from 100 Hz to 10 MHz. The plasma discharge can have an inner burst pulse frequency of from about 100 Hz to 10 MHz. The voltage applied to the electrodes can be from 1-50 kV.

The gas/liquid/plasma reactor can include at least one inlet to the gas/liquid/plasma reactor. The inlet can include an inlet electrode, wherein the liquid and the gas are charged inside the inlet by the inlet electrode. The inlet injects the charged liquid and gas into the gas/liquid/plasma reactor. The injecting of the charged liquid and gas generates a continuously flowing liquid film region with the liquid on one or more internal walls of the gas/liquid/plasma reactor and with a gas stream of the gas flowing along the flowing liquid film region. The injecting further propagates a plasma discharge channel pattern along the interface between the flowing liquid film region and the flowing gas stream inside the gas/liquid/plasma reactor. An outlet can include an outlet electrode.

The present invention utilizes a gas/liquid/plasma reactor. The size, design, construction and method of operation of the gas/liquid/plasma reactor can vary. Examples of suitable gas/liquid/plasma reactors include those shown in the following United States patents: 1) Locke, B. R., Alabugin, I., Wandell, R., Hsieh, K., Bresch, S., Organic Chemical Synthesis using Plasma Reactors with Liquid Organic and Liquid Water, issued on Jan. 9, 2018 as U.S. Pat. No. 9,861,950; 2) Locke, B. R. Wandell, R. R., Simultaneous On-Site Production of Hydrogen Peroxide and Nitrogen Oxides from Air and Water in a Low Power Flowing Liquid Film Plasma Discharge for Use in Agriculture, U.S. application Ser. No. 16/205,941, issued Jul. 16, 2019 as U.S. Pat. No. 10,350,572; 3) Locke, B. R., Tang, Y., Wandell, R., Gas-Liquid Plasma and Bioreactor System and Method for Remediation of Liquids and Gases, issued Feb. 11, 2020 as U.S. Pat. No. 10,556,817; 4) Locke, B. R. and R. J. Wandell, Simultaneous On-Site Production of Hydrogen Peroxide and Nitrogen Oxides from Air and Water in a Low Power Flowing Liquid Film Plasma Discharge for Use in Agriculture, issued Mar. 17, 2020 as U.S. Pat. No. 10,589,252; and 5) Locke, B. R., Alabugin, I., Wandell, R., Hsieh, K., Bresch, S., Plasma Discharge Reactor with Flowing Liquid and Gas, issued Apr. 7, 2020 as U.S. Pat. No. 10,610,850. The disclosures of these patents are hereby incorporated fully by reference. Other gas/liquid/plasma reactor designs are possible.

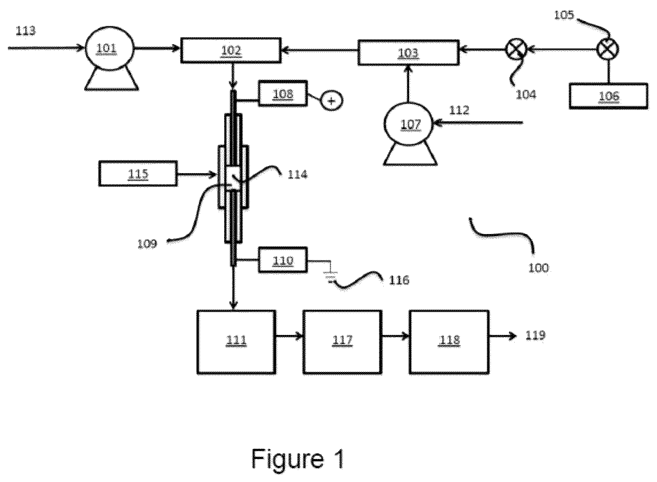

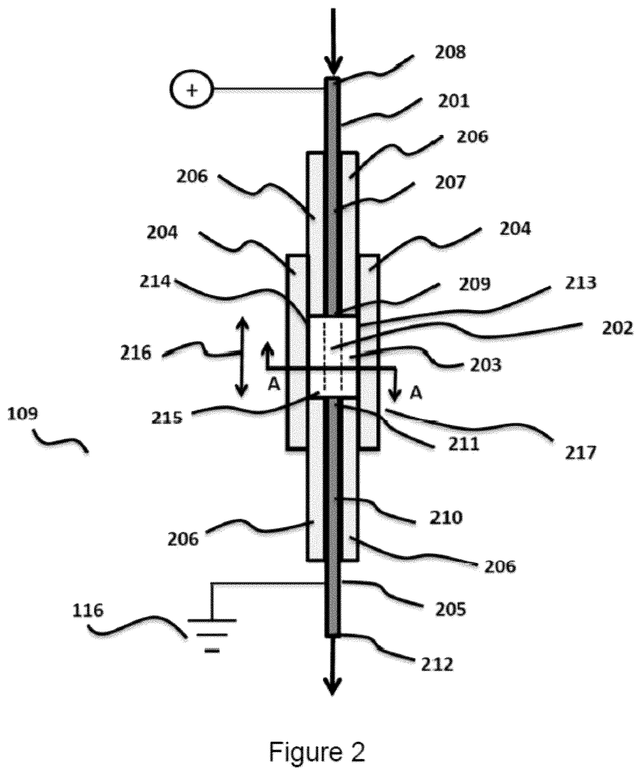

FIG. 1 shows a schematic diagram of a process 100 according to various embodiments. An organic liquid 112, such as n-hexane, can be pumped at a constant rate via a syringe pump 107, into a first mixing zone 103. The system can operate with or without the organic liquid stream using only the liquid water injection. The syringe pump 107 can have a 10 mL glass syringe. The first mixing zone 103 can be a nylon Swagelok tee joint. High pressure argon can be added to the first mixing zone 103 from a high-pressure argon storage container 106 via a pressure regulator 105 where the flow rate is measured by a rotameter 104. Subsequently the organic liquid and the high-pressure argon in the first mixing zone 103 can pass into a second mixing zone 102. The second mixing zone 102 can be a nylon Swagelok tee joint. DI water (or other liquid water solutions) 113 can be pumped via a high-pressure pulse injection pump 101 into a second mixing zone 102. All of the contents of the second mixing zone, the organic liquid, the argon, and the DI water can be added to a reactor 109. The reactor 109 includes a plasma discharge region 114. Emission spectroscopy and/or high speed imaging 115 can be performed on the reactor 109. A high voltage (HV) probe 108 can be used to measure the voltage applied to the reactor. At the outlet of the reactor a shunt 110 can be used to measure the electrical current and thereby in combination with the voltage determine the power delivered to the reactor. A liquid effluent trap 111 can be used to collect the liquid exiting the reactor for subsequent chemical analysis. A power source 116 can supply a voltage at least one electrically-conductive inlet capillary and at least one electrically-conductive outlet capillary of the reactor 109, which are illustrated in greater detail in FIG. 2. Primary 117 and secondary 118 cold traps consisting of dry ice and acetone can also be employed to condense vaporized products not collected in the liquid effluent trap prior to the gas effluent exit 119.

FIG. 2 shows an illustration of a vertical cross section of the plasma reactor 109 according to various embodiments. FIG. 2 shows a vertical cross section diagram of the reactor 109. Because of its simple construction from pre-fabricated materials, an added benefit to this reactor design is that it can be considered “disposable.”

The reactor 109 can include a body portion 217 having one or more internal walls 213, 214 that define an internal cavity 215. According to various embodiments, and as shown in FIG. 2, the body portion 217 can be cylindrical. The reactor 109 can include at least one electrically-conductive inlet capillary 201 having an inlet capillary body 207 extending between a fluid-receiving tip 208 and a fluid-injecting tip 209. The fluid-receiving tip 208 is positioned outside the internal cavity 215, and the fluid-injecting tip 209 is positioned inside the internal cavity 215.

The reactor can include at least one electrically-conductive outlet capillary 205 having an outlet capillary body 210 extending between a fluid-collecting tip 211 and a fluid-ejecting tip 212. The fluid-collecting tip 211 is positioned inside the internal cavity 215, and the fluid-ejecting tip 212 is positioned outside the internal cavity 215. The electrically-conductive inlet capillary 201 and the electrically-conductive outlet capillary 205 can be made of any electrically conductive material, for example, according to one particularly preferred embodiment the electrically-conductive inlet capillary 201 and the electrically-conductive outlet capillary 205 can be made a 316 stainless steel capillary tubing with an outer diameter (O.D.) of 1.59 mm (Restek). Other electrically-conductive materials, as described herein can also be employed. The capillaries can also be any shape, but are preferably cylindrical.

The fluid injecting tip 209 can be disposed relative to the fluid collecting tip 211 to generate a flowing liquid film region 203 on the one or more internal walls 213, 214 and a gas stream or a gas flow region 202 flowing through the flowing liquid film region 203, when a fluid is injected into the internal cavity 215 via the at least one electrically conductive inlet capillary 201. The fluid injecting tip 209 can be disposed relative to the fluid collecting tip 211 to propagate a plasma discharge along the flowing liquid film region 203 between the at least one electrically-conductive inlet capillary 201 and the at least one electrically-conductive outlet capillary 205. According to various embodiments, the fluid injecting tip 209 can be aligned with the fluid collecting tip 211.

According to particularly preferred embodiments, the internal walls 213, 214 can be the inner walls of a piece of fused quartz tubing 204 with an I.D. of 3.0 mm (AdValue Technology) which can serve as a viewing port for emission spectroscopy and high speed imaging. According to other particularly preferred embodiments, the electrically-conductive inlet capillary 201 and the electrically-conductive outlet capillary 205 can be incased by fused quartz tubing spacers 206 with an I.D. of 1.6 mm (AdValue Technology); the tubing 206 can be positioned such that the ends of the stainless steel and quartz tube spacers are flush at the entrance and exit of the discharge region, i.e. the internal cavity 215. These inlet and outlet assemblies comprising the electrically-conductive inlet capillary 201 and the electrically-conductive outlet capillary 205 incased by fused quartz tubing spacers 206 can then inserted into either end of the tubing 204.

The fluid injecting tip 209 and the fluid collecting tip 211 (or when employed, the respective ends of the inlet and outlet assemblies) can be positioned such that a gap 216 having a length. The gap 216 can have a length within a range having a lower limit and/or an upper limit. The range can include or exclude the lower limit and/or the upper limit. The lower limit and/or upper limit can be selected from 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, 12, 12.1, 12.2, 12.3, 12.4, 12.5, 12.6, 12.7, 12.8, 12.9, 13, 13.1, 13.2, 13.3, 13.4, 13.5, 13.6, 13.7, 13.8, 13.9, 14, 14.1, 14.2, 14.3, 14.4, 14.5, 14.6, 14.7, 14.8, 14.9, 15, 15.1, 15.2, 15.3, 15.4, 15.5, 15.6, 15.7, 15.8, 15.9, 16, 16.1, 16.2, 16.3, 16.4, 16.5, 16.6, 16.7, 16.8, 16.9, 17, 17.1, 17.2, 17.3, 17.4, 17.5, 17.6, 17.7, 17.8, 17.9, 18, 18.1, 18.2, 18.3, 18.4, 18.5, 18.6, 18.7, 18.8, 18.9, 19, 19.1, 19.2, 19.3, 19.4, 19.5, 19.6, 19.7, 19.8, 19.9, 20, 20.1, 20.2, 20.3, 20.4, 20.5, 20.6, 20.7, 20.8, 20.9, 21, 21.1, 21.2, 21.3, 21.4, 21.5, 21.6, 21.7, 21.8, 21.9, 22, 22.1, 22.2, 22.3, 22.4, 22.5, 22.6, 22.7, 22.8, 22.9, 23, 23.1, 23.2, 23.3, 23.4, 23.5, 23.6, 23.7, 23.8, 23.9, 24, 24.1, 24.2, 24.3, 24.4, 24.5, 24.6, 24.7, 24.8, 24.9, and 25 mm. For example, according to certain preferred embodiments, the gap 216 can have a length of about 4 mm.

The reactor can also include a power source 116, supplying a voltage across the at least one electrically-conductive inlet capillary and the at least one electrically-conductive outlet capillary. The power source 116 can be adapted to provide a pulsed current, a D.C. current, and/or an A.C. current, a nanosecond pulser and/or burst mode operation between the at least one electrically-conductive inlet capillary 201 and the at least one electrically-conductive outlet capillary 205.

A ratio of the voltage to the length of the gap 216 can be within a range having a lower limit and/or an upper limit. The range can include or exclude the lower limit and/or the upper limit. The lower limit and/or upper limit can be selected from 2.5×10⁵ V/m, 3×10⁵, 4×10⁵, 5×10⁵, 6×10⁵, 7×10⁵, 8×10⁵, and 9×10⁵ V/m. For example, the body portion 217 can have a length, and a ratio of the voltage to the length can be at least about 2.5×10⁵ V/m.

According to various embodiments, the body portion 217 can be cylindrical. The cylindrical body portion 217 can have a first diameter within a range having a lower limit and/or an upper limit. The range can include or exclude the lower limit and/or the upper limit. The lower limit and/or upper limit can be selected from 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, 0.5, 0.51, 0.52, 0.53, 0.54, 0.55, 0.56, 0.57, 0.58, 0.59, 0.6, 0.61, 0.62, 0.63, 0.64, 0.65, 0.66, 0.67, 0.68, 0.69, 0.7, 0.71, 0.72, 0.73, 0.74, 0.75, 0.76, 0.77, 0.78, 0.79, 0.8, 0.81, 0.82, 0.83, 0.84, 0.85, 0.86, 0.87, 0.88, 0.89, 0.9, 0.91, 0.92, 0.93, 0.94, 0.95, 0.96, 0.97, 0.98, 0.99, 1, 1.01, 1.02, 1.03, 1.04, 1.05, 1.06, 1.07, 1.08, 1.09, 1.1, 1.11, 1.12, 1.13, 1.14, 1.15, 1.16, 1.17, 1.18, 1.19, 1.2, 1.21, 1.22, 1.23, 1.24, 1.25, 1.26, 1.27, 1.28, 1.29, 1.3, 1.31, 1.32, 1.33, 1.34, 1.35, 1.36, 1.37, 1.38, 1.39, 1.4, 1.41, 1.42, 1.43, 1.44, 1.45, 1.46, 1.47, 1.48, 1.49, 1.5, 1.51, 1.52, 1.53, 1.54, 1.55, 1.56, 1.57, 1.58, 1.59, 1.6, 1.61, 1.62, 1.63, 1.64, 1.65, 1.66, 1.67, 1.68, 1.69, 1.7, 1.71, 1.72, 1.73, 1.74, 1.75, 1.76, 1.77, 1.78, 1.79, 1.8, 1.81, 1.82, 1.83, 1.84, 1.85, 1.86, 1.87, 1.88, 1.89, 1.9, 1.91, 1.92, 1.93, 1.94, 1.95, 1.96, 1.97, 1.98, 1.99, and 2 cm. For example, according to certain preferred embodiments, the cylindrical body portion 217 can have a first diameter 0.1 to 1 cm. The at least one electrically-conductive inlet capillary can have a second diameter that is less than the first diameter. The at least one electrically-conductive outlet capillary can have a third diameter that is greater than the second diameter and less than the first diameter.

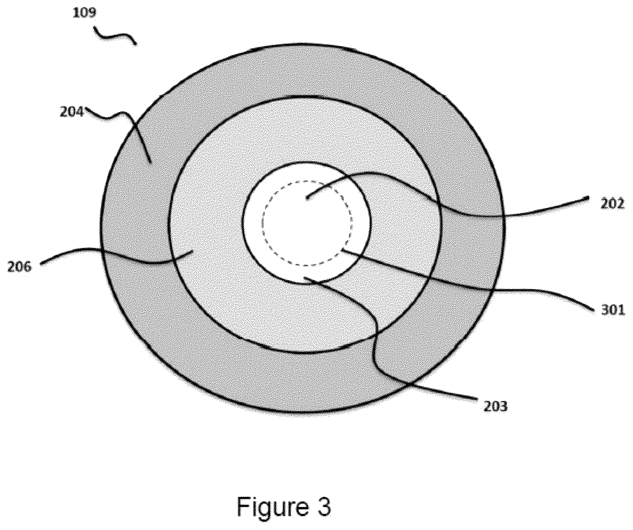

FIG. 3 shows an illustration of a radial cross section along line A-A as shown in FIG. 2 of the plasma reactor 109 according to various embodiments. The gas flow region 202 can be bounded by a gas/liquid interface 301, separating the gas flow and plasma discharge region 202 from the liquid film flow region 203. The gas/liquid interface 301 can be, but need not always be highly turbulent. As discussed under FIG. 2, the liquid film flow region 203 flows along the fused quartz tubing 204 which acts as the reactor wall.

It should be noted that the invention is not limited to any particular reactor construction/configuration but is more broadly applicable to any configuration which generates the gas/liquid/plasma interactions. The embodiment of FIG. 1 will generate a pulsed plasma discharge propagates for a period of time (1 ns to 1000 ns) at frequencies between (1 Hz to 100 kHz) along the interface of a flowing liquid phase with a residence time of (1 to 250 ms) and a flowing gas phase with a residence time of (0.1 to 5 ms).

The following terminology is applicable:
Burst mode—The setting on the function generator that allows a “burst” of high frequency pulses to be sent at an “overall outer burst frequency”
Burst—Train of high frequency pulses sent by the power supply to the reactor (single burst)
Inner (internal) burst frequency—Frequency of the pulses inside of a single burst in a range of 100 Hz to 10 MHz
Inner burst relaxation time—Time scale between pulses within a burst
Outer burst frequency—Overall frequency of the bursts sent by the power supply in a range of 100 Hz to 10 MHz
Burst period—Time scale of a single burst (initial strike to last restrike)
Outer Burst Relaxation time—Time scale between bursts
N-cycles or number of pulses in a burst—the number or individual pulses within a burst.
Memory effect—The reason why the breakdown voltage of a restrike is less than that of an initial strike. *This also causes restrikes to occurs in the same spatial location as the initial strike.
Initial strike—The first plasma channel generated in a burst
Restrike—Subsequent plasma channels after the initial strike that have a lower breakdown voltage and power within a burst
Initial strike voltage—The breakdown voltage of the initial strike
Restrike voltage—The breakdown voltage of restrikes
Initial strike current—The peak current of the initial strike
Restrike current—The peak current of restrikes
Initial strike energy—Energy dissipated in the initial strike
Restrike energy—Energy dissipated in individual restrikes
Total burst energy—Total energy dissipated by all the pulses in a single burst
Discharge power—Average power of the plasma discharge

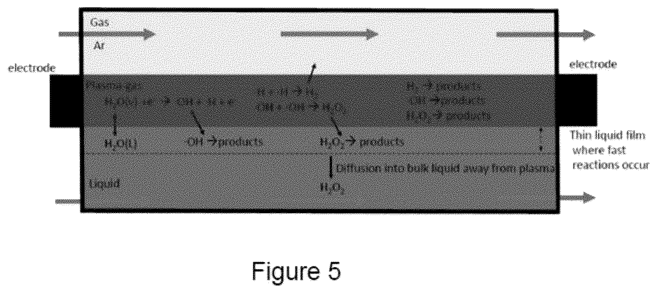

The formation of useful chemical species such as H₂ and H₂O₂ by plasma chemical reactions depends upon the tradeoff between reactions that form these species and reactions that degrade these species. Ideally, the objective is to promote the formation reactions while suppressing the degradation reactions. This is complicated by the extensive set of highly reactive species generated in the plasma. In the case of plasma contacting liquid water, the plasma, which contains energetic free electrons, causes water to be dissociated into two key species, namely the hydrogen radical, H·, and the hydroxyl radical, ·OH, as shown in FIG. 5. The hydrogen radical can recombine to make H₂, and the hydroxyl radicals can recombine to make H₂O₂. These are examples of the forward product-generating reactions. However, both H₂ and H₂O₂ can be degraded by reactive plasma species (including the ·OH). Therefore, it is of interest to find ways to promote the formation reactions while minimizing the degradation reactions. One way to reduce degradation reactions is to have very fast plasma pulses so that the forward reaction is favored and the time for reverse reactions suppressed. Another way is to have a second phase, such as water, that can take up the product, for example H₂O₂, into the liquid where the degradation reactions are slower. In addition, the residence times of the gas and liquid, i.e., the average contact time in the reactor, along with the times for the plasma pulse, diffusion times, and reaction times, affect the relative rates of formation and degradation.

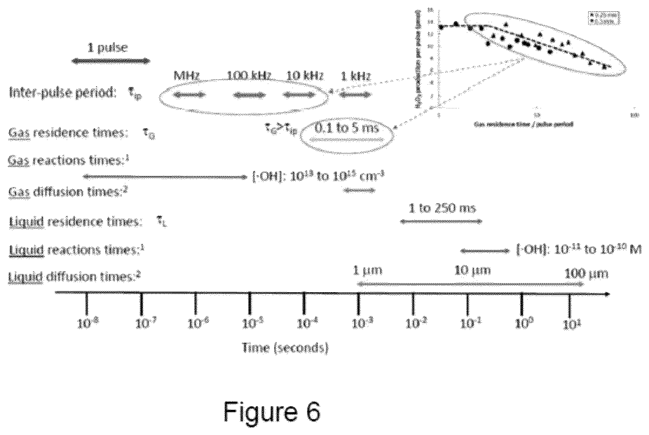

FIG. 6 shows the time scales for the major factors including inter-pulse period, gas and liquid residence times, gas and liquid diffusion times, and gas and liquid reaction rates. The time scales among these different processes span many orders of magnitude and these are key to the present invention. FIG. 6 is a depiction of the various time scales and operational variables involved in burst mode operation. The inner burst relaxation time is on a similar time scale of the plasma interactions (electron excitation, cleavage, and relaxation), while the outer burst relaxation time is on a similar time scale of the gas phase residence time, gas phase chemical reactions, and mass transfer between the liquid and gas phases. These two parameters can be independently manipulated to “tune” the system to enhance the efficiency of the desired reactive chemistry.

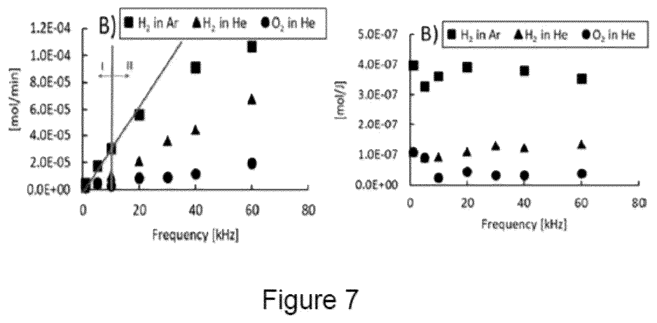

FIG. 7 shows experimental data on the production of H₂ with frequency. As shown by the diagonal line, the production rate linearly increases up to a frequency of about 10 kHz, labeled region I. Above 10 kHz, the production rate deviates from linearity and the amount of deviation increases with frequency, labeled region II.

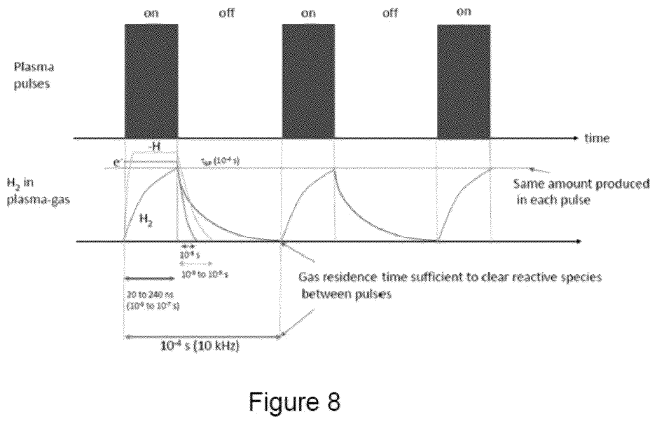

FIG. 8 shows a schematic depiction of the plasma-gas phase reactions for ·H and H₂ relative to the pulses that occur in the region I of FIG. 7 and the base case without burst mode. According to experimental data with time resolved electron density measurements, the formation of ·H is very fast and occurs within the pulse-on period, even for 20 to 240 ns pulses. The time scale for H₂ generation with the pulse can be longer such that the H₂ concentration in the plasma is rising during the pulse-on period. For these short pulses, the H₂ has not reached a limiting (maximum concentration) in one pulse. During the inter-pulse period H₂ drops as it flows out of the reactor with the gas phase carrier. If the gas phase residence time is long enough relative to the degradation reactions (region I), all the H₂ is swept out of the reactor between pulses and therefore each pulse produces the same amount of H₂, hence leading to a linear increase with frequency. The no burst case corresponds to FIG. 7 region I where inter-pulse period allows complete recovery between pulses. The same amount of H₂ produced in each pulse leading to a linear increase in production rate with frequency (see FIG. 7 region I). The schematic depictions in FIGS. 8, 9, 10, 12, 13, and 14 are simplified situation where by each pulse is assumed to have the same plasma properties of electron density and energy and is dependent upon the power supply and reactor capable of suppling identical pulses which would be difficult to achieve at high frequencies due to the memory effect.

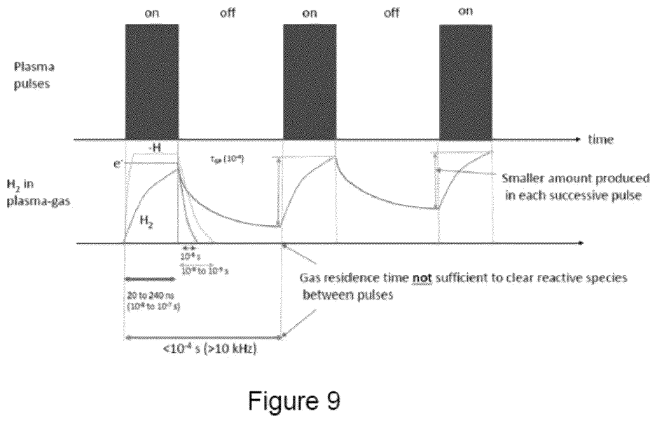

At higher frequency, as shown in FIG. 9, there is not sufficient time between pulses for all the H₂ to be swept out of the reactor. As shown, each pulse produces less H₂ due to the degradation reactions and the overall production rate will start to level off as shown in the data of FIG. 7 (region II).

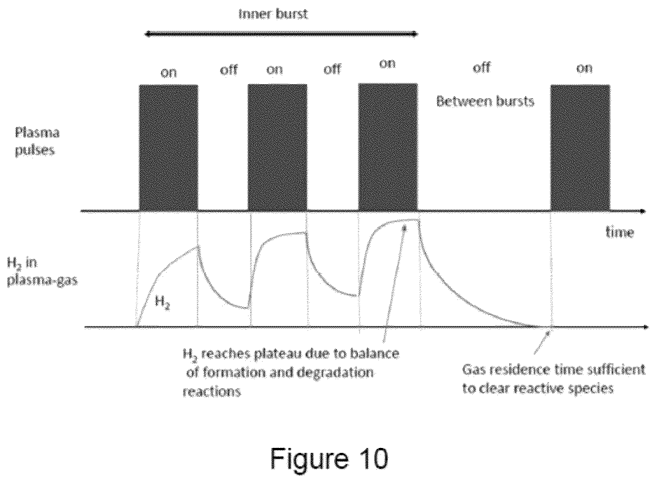

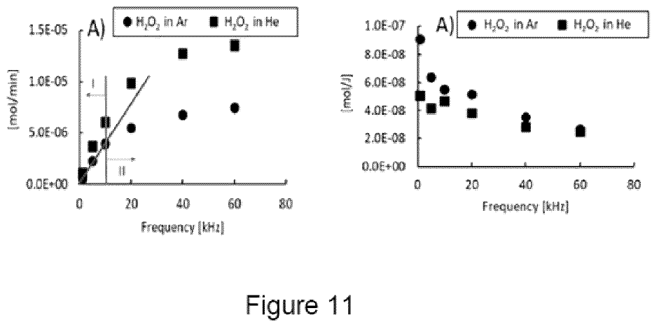

FIG. 10 shows what happens during the inner burst period whereby gradually, from pulse to pulse the concentration of H₂ increases until it levels off. At this point the formation reactions are balanced by the degradation reactions and further evenly spaced pulsing does not lead to enhancement in H₂ concentration (FIG. 7). In this case energy would be wasted with further pulsing because the reverse (degradation) reactions would be suppressing further formation of the desired product. The inner burst corresponds to region II of FIG. 7 where the inter-pulse period does not allow complete recovery between pulses. Smaller amounts of H₂ are produced in each pulse leading to a drop in the increase in production rate with frequency (see FIG. 7 region II). Again, this schematic depiction assumes that the plasma properties for each pulse with increasing frequency are identical.

As shown in FIG. 10, a burst mode, i.e., a longer inter-pulse period allows the gas phase H₂ concentration to reset to zero, and therefore stops the reverse reactions. The data (FIG. 7) shows that for uniform increasing frequency (no burst) the production of H₂ increases linearly with frequency up to between 10 kHz and then has a curvature occurring with the argon carrier gas above 10 kHz indicates that degradation reactions are starting to play a role. Adding bursts allows operation at higher frequency to increase production rate by allowing clearance of reactive degradation species between bursts.

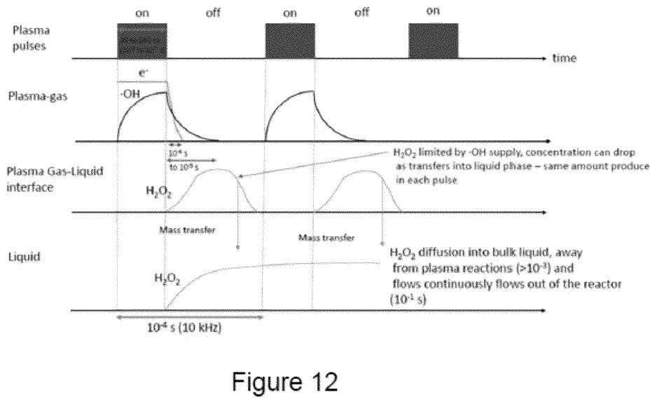

FIG. 11 shows the data for the case of H₂O₂ whereby the H₂O₂ has a linear increase to 10 kHz with a similar deviation above 10 kHz as seen with H₂. As shown in FIG. 12, H₂O₂ is more complicated since it is formed in the gas-liquid interface, and it diffuses into the liquid phase where it is highly soluble. During the pulse-on period ·OH is formed in the plasma-gas and during the pulse-off period these ·OH recombine to form H₂O₂ in the gas-liquid interface. During the inner burst pulse period, the H₂O₂ builds up in the liquid phase as it transfers from the film. The maximum H₂O₂ that can be formed is limited by the ·OH supply. H₂O₂ transfers from the film into the liquid where it flows out of the reactor with a liquid phase residence time of 10⁻³ to 10⁻¹ s. The H₂O₂ deep in the liquid phase is less susceptible to back reactions caused by plasma reactive species because they have less ability to penetrate deeply into the liquid. The trends for H₂O₂ are similar to those for H₂ (FIG. 7) whereby above about 10 kHz the production rate deviates from linearity due to degradation reactions. Again, this assumes that the plasma properties for each pulse with increasing frequency are the same.

As shown in FIG. 12 in the case without bursts and in region I corresponding to FIG. 11, the same amount of H₂O₂ is produced during each pulse so the increase in production rate with frequency is linear and the concentration in the liquid is constant. Again, this assumes that the plasma properties for each pulse with increasing frequency are the same.

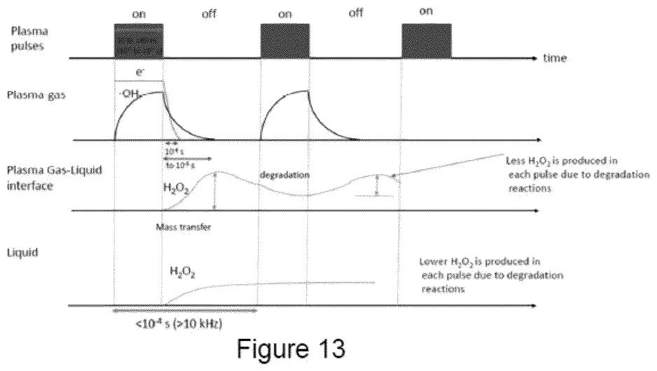

FIG. 13 shows the case of H₂O₂ when the frequency is high enough such that there is interference between pulses. The H₂O₂ in the plasma gas-liquid interface is subject to degradation by plasma reactions and the amount produced from pulse-to-pulse decreases. This leads to the behavior shown in FIG. 11 (region II) as well as that shown in insert of FIG. 6.

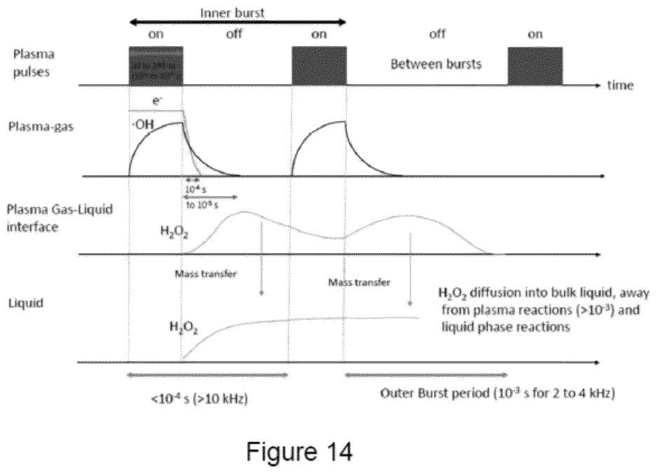

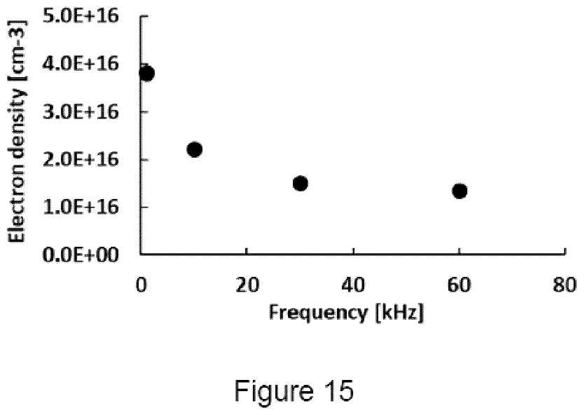

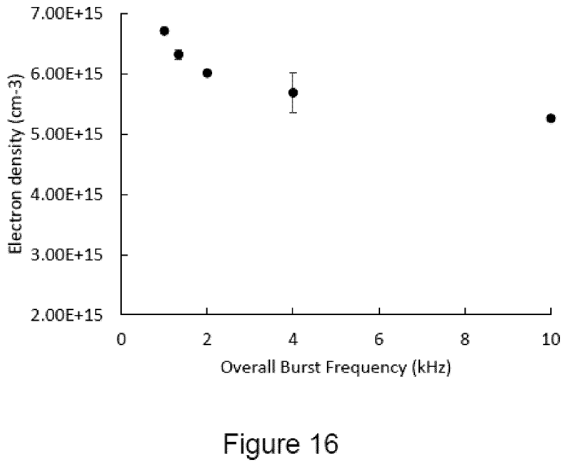

Adding the burst mode for the H₂O₂ generation is shown in FIG. 14 where the utilization of a 2 to 4 kHz outer burst period reduces the amount of back degradation reactions which should improve the energy efficiency. FIG. 15 shows the experimental data of electron density decreasing with uniform pulse frequency between 1-60 kHz. FIG. 16 shows the decreasing electron density decreasing with outer burst frequency between 1-10 kHz at constant internal frequency of 100 kHz and 5 N-cycles.

The following mathematical model was developed for the case of H₂ and H₂O₂ production from deionized water, however it should be noted that the equations below could be modified to accommodate other chemical systems such as plasma activated water (PAW) production or degradation of dyes, pharmaceuticals, and poly-fluorinated compounds (PFOA/PFOS). This model is based upon the ideal case where each pulse has similar electrical and plasma properties as the frequency is increased. Deviations from this assumption are expected (as indicated above in FIGS. 15 and 16 where electron density varied with pulses) and will require modification of modeling approaches to account for changes of these properties as per the characteristics and ability of a given power supply to provide them. As with FIGS. 8, 9, 10, 12, 13, and 14, the mathematical model also assumes that each pulse has the same plasma properties of electron density and energy when varying burst parameters (burst period, inner burst frequency, N-cycles). This assumption is dependent upon the power supply and reactor capable of inducing identical plasma pulses. The shown experimental data suggests that the power supply utilized in these experiments does not result in identical pulses which lead to the varying plasma properties of electron density as shown in FIGS. 15 and 16 which resulted in variations in reaction chemistry of decoloration of MB.

Considering the case of four components, H₂O₂, ·OH, ·H, and H₂ in two phases (plasma-gas and liquid) as shown in FIG. 5, the mass balances for these cases can be given as shown below.

### Reactions in Plasma-Gas

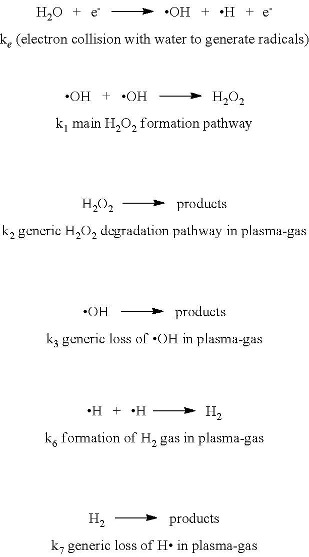

### Liquid Phase

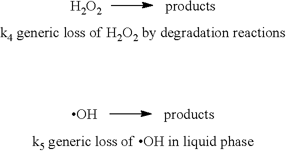

Plasma-Gas Phase·H₂O₂ balance (species HPG), includes flow terms, generation by ·OH recombination (k₁), generic first order loss term (k₂), and mass transfer from the gas to the liquid phase.

$$\frac{{dC}_{HPG}}{dt} = \frac{{C}_{HPG}^{in} - {C}_{HPG}}{{τ}_{GP}} + {{k}_{1} ( {C}_{OHG} )}^{2} - {k}_{2} {C}_{HPG} - \text{?} A / {V}_{GP} ( {C}_{HPG} {H}_{HP} - {C}_{HPL} )$$

$$\text{?} \text{indicates text missing or illegible when filed}$$

A similar balance for the ·OH (species OH) in the plasma gas-phase includes a zero-order source term, kₑ, and similar first order loss and mass transfer from the gas phase to the liquid phase.

$$\frac{{dC}_{OHG}}{dt} = \frac{{C}_{OHG}^{in} - {C}_{OHG}}{{τ}_{GP}} + \text{?} - {{k}_{1} ( {C}_{OHG} )}^{2} - {k}_{3} {C}_{OHG} - \text{?} A / {V}_{GP} ( {C}_{OHG} \text{?} - \text{?} )$$

$$\text{?} \text{indicates text missing or illegible when filed}$$

The balances on ·H (species H) and H₂ (species H₂) in the plasma gas phase are given in Eq.(1.3) and Eq.(1.4), respectively. The transfer of ·H or H₂ into the liquid phase or any reactions of these species in the liquid are not included because of their low solubility and recent research demonstrating no H reactions in the bulk liquid. ·H is formed by the same reaction with plasma electrons as ·OH, and H₂ is formed by recombination of H. Also included is a general first order loss term for H₂.

$$\frac{{dC}_{HG}}{dt} = \frac{{C}_{HG}^{in} - {C}_{HG}}{{τ}_{GP}} + \text{?} - {{k}_{6} ( {C}_{HG} )}^{2} \qquad ( 1.3 )$$

$$\frac{{dC}_{H 2 G}}{dt} = \frac{{C}_{H 2 G}^{in} - {C}_{H 2 G}}{{τ}_{GP}} + {{k}_{6} ( {C}_{HG} )}^{2} - {k}_{7} {C}_{H 2 G} \qquad ( 1.4 )$$

$$\text{?} \text{indicates text missing or illegible when filed}$$

Liquid Phase—The balances in the liquid phase include the flow terms, reaction losses and mass transfer from the plasma-gas for both H₂O₂ and ·OH.

$$( 1.5 )$$

$$\frac{{dC}_{HPL}}{dt} = \frac{{C}_{HPL}^{in} - {C}_{HPL}}{{τ}_{L}} - {k}_{4} {C}_{HPL} + \text{?} A / {V}_{L} ( {C}_{HPG} {H}_{HP} - {C}_{HPL} )$$

$$( 1.6 )$$

$$\frac{{dC}_{OHL}}{dt} = \frac{{C}_{OHL}^{in} - {C}_{OHL}}{{τ}_{L}} - {k}_{5} {C}_{OHL} + \text{?} A / {V}_{L} ( {C}_{OHG} {H}_{OH} - {C}_{OHL} )$$

$$\text{?} \text{indicates text missing or illegible when filed}$$

It can be noted that the above balances assume well mixed plasma-gas and liquid phases. This assumption may need to be relaxed for the liquid phase in future analysis. For example, it is possible to consider the reactions of the species from the plasma-gas with liquid phase species occurring close to the liquid interface and diffusion time scale estimates are used to assess these possibilities. Another assumption that needs further refinement is the presence of the flowing gas phase (not plasma region); during the plasma off period, the species that were generated and in the plasma-on period are rapidly transferred into the flowing gas phase not only by diffusion but also be the convective flow. Neither of these effects are expected to change the general conclusions given here which are based upon the key order of magnitude analysis of the factors involved.

If the Henry's law constants for H₂O₂ and ·OH are sufficiently large, the mass transfer terms can be simplified. Transfer of H₂ and H· into the liquid phase are neglected due to their very low solubilities as mentioned above.

$${C}_{HPG} {H}_{HP} >> {C}_{HPL} \qquad ( 1.7 )$$

$${C}_{OHG} {H}_{OH} >> {C}_{OHL}$$

### Parameter Estimates

FIG. 6 shows the time scales for the various processes. The gas and liquid residence times are given in Eq.(1.8)

$${τ}_{G} = 0.1 ms \qquad ( 1.8 )$$

$${τ}_{GP} = {τ}_{G}$$

$${τ}_{L} = 100 ms$$

It can be assumed that the plasma-gas phase has the same residence time as the gas phase. The following quantities can be estimated:
VP=volume of the plasma as 0.9 to 3.3×10⁻⁴ cm³
VL=volume of the liquid as 2 to 12 mm³
VGF=volume of the entire gas phase
VGP=volume of plasma 0.9 to 3.3×10⁻⁴ cm³ (4 mm long, r=10⁻² cm)
AGL=gas-liquid contact area of 30 to 40 mm²
A=2.5×10⁻⁴ cm² plasma liquid contact area [based upon diameter of plasma channel]
kmt=mass transfer coefficient between the liquid and plasma is in the range 6 to 12 m/s
Gas reaction times: 10⁻⁸ to 10⁻⁵ s based upon [·OH]10¹³ to 10¹⁵ cm⁻³
Liquid reaction times: 10⁻¹ to 1 s based upon [·OH]10⁻¹¹ to 10⁻¹⁰ M (These are based upon bulk phase concentrations and rates are likely much higher at the interface.)
Gas (first order): k₂, k₃, k₇=10⁵ to 10⁸ s⁻¹
Gas phase diffusion-controlled reaction—second order rate constants k~10¹⁴ M⁻¹s⁻¹, 10¹⁷ cm³/s-mol, 10⁻⁷ cm³/s: if [·OH]~10¹³ to 10¹⁵ cm⁻³; k 10⁵ to 10⁸ s⁻¹; 1/k 10⁻⁵ to 10⁻⁸ s
Gas (second order) k₁, k₆=10¹⁴ M⁻¹s⁻¹, 10¹⁷ cm³/s-mol, 10⁻⁷ cm³/s
Liquid phase diffusion-controlled reaction—second order rate constants 10¹⁰ M⁻¹ s⁻¹, if [·OH]~10⁻¹¹ to 10⁻¹⁰ M; k 0.1 to 1 s⁻¹; 1/k 1 to 10 s (note [·OH] can likely be much higher at the interface—this estimate is based upon bulk average [·OH]).
k₄, k₅=0.1 to 1.0 s⁻¹
H_{HPS}=1000 mole/m³-Pa (Henry law constant for H₂O₂)
H_{HP}=H_{HPs}RT=2.5×10⁶ (dimensionless−R=8.314 m³ Pa/K-mole, T=300K)
H_{OHs}=0.38 mole/m³-Pa (Henry law constant for ·OH)
H_{OH}═H₂ₛRT=9.48×10²
H_{Hs}=2.6×10⁻⁶ mole/m³-Pa (Henry law constant for ·H)
H_{H}═H₃ₛRT=6.5×10⁻³
H_{H2s}=7.7×10⁻⁶ mole/m³-Pa (Henry law constant for H₂)
H_{H2}=H_{H2s}RT=1.9×10⁻²
kₘₜAH₁/V_{L}=6.3×10⁷ s⁻¹; time scale 10⁻⁸ s
kₘₜAH₂/V_{L}=2.4×10⁴ s⁻¹; time scale 10⁻⁵ s
kₘₜAH₁/VGP=6.3×10⁹ s⁻¹; time scale 10⁻¹⁰ s
kₘₜAH₂/VGP=2.4×10⁶ s⁻¹; time scale 10⁻⁷ s

### Hydrogen Analysis

Since the balances on H₂ and ·H in the plasma-gas are independent of the H₂O₂ and ·OH, the analysis begins with those two species. The Eq.(1.3) can be solved directly through separation of variables assuming that the feed gas does not contain any H. The solution to Eq.(1.3) is given by Eq. (1.9).

$${C}_{HG} = \frac{( \frac{1}{{τ}_{GP}} + \sqrt{q} ) \frac{exp ( - t \sqrt{q} )}{Ω} - ( \frac{1}{{τ}_{GP}} - \sqrt{q} )}{2 {k}_{6} ( 1 - \frac{exp ( - t \sqrt{q} )}{Ω} )} \qquad ( 1.9 )$$

$$q = \frac{1}{{τ}_{GP}^{2}} + 4 {k}_{6} {k}_{e}$$

$$Ω = \frac{2 {k}_{6} {C}_{3 G}^{0} + \frac{1}{{τ}_{GP}} + \sqrt{q}}{2 {k}_{6} {C}_{3 G}^{0} + \frac{1}{{τ}_{GP}} - \sqrt{q}}$$

The time scale for the exponential function is governed by the value of the square root of q. This factor includes the residence time in the plasma-gas and the product of the reactions rate constants. The larger the value of q the faster the exponential function decays and the steady-state is reached. This can be controlled by either the residence time (shorter residence times lead to faster steady-states as is intuitively clear) or the reaction rates (faster rates lead to faster steady-states). The gas phase residence time is 0.1 ms. Estimation of k₆ comes from the diffusion limited reaction rate constants for second order reactions in the gas phase 10¹⁴ M⁻¹s⁻¹. Estimation of kₑ is more difficult and uncertain. This rate will depend upon water content, electron density, and electron energy. Electron density was measured in the range of 10¹⁸ molecules/cm³ (10⁻³M) which is of same order as water vapor and Tₑ of order 1 eV. The value of kₑ is a function of the electron cross-sectional area however for Tₑ in range up to 5 eV rotational excitation is the main mechanism for water dissociation with rate constants of order 10⁻¹² m³/s (10¹⁵ M⁻¹s⁻¹). Using the water and electron densities this gives a value of kₑ of 10⁹ M/s and clearly the product of k₆kₑ dominates the value of q and the steady-state for ·H generation is reached in 10⁻¹² s. This indicates that the water dissociation reaction is very fast compared to the gas residence time.

FIG. 7 shows experimental data on the production of H₂ with frequency. As shown by the diagonal line, the production rate linearly increases up to a frequency of about 10 kHz, labeled region I. Above 10 kHz, the production rate deviates from linearity and the amount of deviation increases with frequency, here labeled region II. FIG. 8 shows a schematic of the plasma-gas phase reactions for ·H and H₂ relative to the pulses that occur in the region I and the base case without burst mode. The formation of ·H is very fast and occurs within the pulse-on period, even for 20 to 240 ns pulses. This result is based upon experimental data with time resolved electron density measurements. The time scale for H₂ generation with the pulse can be longer such that the H₂ concentration in the plasma is rising during the pulse-on period. For these short pulses, the H₂ has not reached a limiting (maximum concentration) in one pulse. During the inter-pulse period H₂ drops as it flows out of the reactor with the gas phase carrier. If the gas phase residence time is long enough relative to the degradation reactions (region I), all the H₂ is swept out of the reactor between pulses and therefore each pulse produces the same amount of H₂, hence leading to a linear increase with frequency.

If the pulse-on time is shorter than the time scale for the H₂ to reach steady-state than the concentration continues to build up from pulse to pulse until it eventually levels off after many pulses (FIG. 9). At this point more pulses do not lead to higher concentrations of the products in the plasma region. The advantage of utilizing the burst mode is shown in FIG. 10 where the time scale between pulses is sufficient to sweep all reactive species out of the plasma-gas phase region and reset the process for another round of pulses in the inner bursts.

The steady-state solution for H is equal to the positive root of the quadric form in Eq.(1.10)

$${k}_{6} {C}_{HG}^{2} + \frac{{C}_{HG}}{{τ}_{GP}} - {k}_{e} = 0 \qquad ( 1.1 )$$

$${C}_{HG}^{SS} = \frac{- \frac{1}{{τ}_{GP}} + \sqrt{q}}{2 {k}_{6}}$$

Increasing kₑ (production rate of ·H) increases the steady-state concentration while increasing k₆ lowers the steady-state concentration due to conversion to H₂. The steady-state concentration of H₂ is given by Eq.(1.11) and this also shows that higher electron density leads to higher ·H and H₂.

$${C}_{H 2 G}^{ss} = \frac{{{k}_{6} ( {C}_{HG}^{ss} )}^{2}}{( \frac{1}{{τ}_{GP}} + {k}_{7} )} \qquad ( 1.11 )$$

The time dependence of H₂ is determined by Eq.(1.12).

$$\frac{{dC}_{H 2 G}}{dt} + μ {C}_{H 2 G} = {{k}_{6} ( {C}_{HG} )}^{2} \qquad ( 1.12 )$$

$$μ = ( \frac{1}{{τ}_{GP}} + {k}_{7} )$$

$${C}_{H 2 G} = {C}_{H 2 G}^{0} exp ( - μ t ) + exp ( - μ t ) {\int }_{0}^{t} {{k}_{6} ( {C}_{HG} )}^{2} exp ( μ t ) dt \qquad ( 1.13 )$$

If the initial state is zero and the ·H has reached steady-state (see above—this occurs very rapidly).

$${C}_{H 2 G} = {{k}_{6} ( {C}_{3 G}^{ss} )}^{2} \frac{( 1 - exp ( - μ t ) )}{μ} \qquad ( 1.14 )$$

The time scale for formation of H₂ is governed by 1/μ (10⁻³ To 10⁻⁴ s) which is much slower than the formation of ·H and comparable or slower than the plasma-gas residence time. FIG. 8 shows a schematic of the concentration of H₂ superimposed on ideal pulses with the given time scales. If the frequency of the pulse is less than 10 kHz (times longer than 10⁻⁴ s) the H₂ and all reactive species have time to be cleared from the plasma-gas zone and for reactions to be complete. Thus, there is no interference between one pulse to the next. However, if the frequency is higher than 10 kHz, there is not enough time between pulses for the reactive species, including the product H₂, to clear from the plasma-gas zone so there is a continual increase of H₂ from pulse to pulse (FIG. 9) until eventually there is a balance between that formed and that degraded (FIG. 9—after first three pulses). FIG. 10 shows the effect of adding the burst mode in this situation where during the inner burst period the concentration of H₂ builds until it reaches a balance and the time between bursts allows for clearance of reactive species.

Once the electron density reaches zero (experimentally about 10⁻⁶ s the decay of the ·H is governed by the gas residence time; e.g. by (Eq. (1.9) q for kₑ=0) and that of H₂ by the relative rates of the gas residence time and degradation constant (Eq.(1.15).

$${k}_{e} = 0 \qquad ( 1.15 )$$

$$q = \frac{1}{{τ}_{GP}^{2}}$$

$$exp ( - \sqrt{q} t ) = exp ( - t / {τ}_{GP} )$$

$$μ = \frac{1}{{τ}_{GP}} + {k}_{7} ( {10}^{4} + ( {10}^{5} to {10}^{8} )$$

The degradation rate constant time scale, k₇, can range from 10⁻⁵ to 10⁻⁸ s. The data (FIG. 7) shows that for uniformly increasing frequency (no burst) the production of H₂ increases linearly with frequency up to 10 kHz and then has a curvature occurring with the argon carrier gas above 10 kHz indicates that degradation reactions are starting to play a role. This result is also consistent with the H₂O₂ result (see FIG. 11 and FIG. 6 insert) where H₂O₂ is degraded by gas phase species that are not swept out at high frequency.

The electron density drops with frequency, and this would decrease kₑ and then the concentrations of H and H₂. Although the concentration of H₂ in each pulse is lower with increasing frequency, the production rate increases due to increasing frequency. Since the energy yield is constant (FIG. 7) the moles produced per pulse drops in a similar way as the energy per pulse.

The role of the liquid phase is also important in establishing the importance of the burst mode for this type of chemistry. This is shown for H₂O₂.

H₂O₂ and ·OH in Plasma-Gas

Assuming that no H₂O₂ and ·OH enter with the flowing gas or liquid, and Eq.(1.7) is valid and this gives Eq.(1.16) and Eq.(1.17).

$$\frac{{dC}_{HPG}}{dt} = - \frac{{C}_{HPG}}{{τ}_{GP}} + {{k}_{1} ( {C}_{OHG} )}^{2} - {k}_{2} {C}_{HPG} - {k}_{m i} A / {V}_{GP} ( {C}_{HPG} {H}_{HP} ) \qquad ( 1.16 )$$

$$\frac{{dC}_{OHG}}{dt} = - \frac{{C}_{OHG}}{{τ}_{GP}} + {k}_{e} - {{k}_{1} ( {C}_{OHG} )}^{2} - {k}_{3} {C}_{OHG} - {k}_{m i} A / {V}_{GP} ( {C}_{OHG} {H}_{OH} ) \qquad ( 1.17 )$$

$$\frac{{dC}_{HPL}}{dt} = - \frac{{C}_{HPL}}{{τ}_{L}} - {k}_{4} {C}_{HPL} + {k}_{m i} A / {V}_{L} ( {C}_{HPG} {H}_{HP} ) \qquad ( 1.18 )$$

$$\frac{{dC}_{OHL}}{dt} = - \frac{{C}_{OHL}}{{τ}_{L}} - {k}_{5} {C}_{OHL} + {k}_{m i} A / {V}_{L} ( {C}_{OHG} / {H}_{OH} ) \qquad ( 1.19 )$$

The gas phase ·OH concentration can be determined by solving Eq. (1.17). First consider the steady-state solution given by the roots of the quadratic equation.

$${k}_{1} {C}_{OHG}^{2} + ( {k}_{3} + {k}_{m i} A / {V}_{GP} {H}_{2} + \frac{1}{{τ}_{GP}} ) {C}_{OHG} - {k}_{e} = 0 \qquad ( 1.2 )$$

$$b ≡ ( {k}_{3} + {k}_{m i} A / {V}_{GP} {H}_{2} + \frac{1}{{τ}_{GP}} )$$

$${λ}_{1 , 2} = \frac{- b \pm \sqrt{{b}^{2} + 4 {k}_{1} {k}_{e}}}{2 {k}_{1}}$$

The solution is given by Eq.(1.21).

$${C}_{OHG} = \frac{{λ}_{1} Ω - {λ}_{2} exp ( - δ t )}{Ω - exp ( - δ t )} \qquad ( 1.21 )$$

$$Θ = ( \frac{{C}_{OHG}^{0} - {λ}_{2}}{{C}_{OHG}^{0} - {λ}_{1}} )$$

$$δ = \frac{\sqrt{{b}^{2} + 4 {k}_{1} {k}_{e}}}{{k}_{1}}$$

The δ term governs the time scale for ·OH. For large δ the approach to steady-state is very fast and for small the approach is slow. At t=0 the initial state is met and as time goes to infinity the steady-state solution is reached which is the positive solution in Eq.(1.20), i.e. Eq.(1.22).

(C_{OHG})^{δ}=λ₁ (1.22)

Once the ·OH concentration is determined the H₂O₂ concentration can be determined from Eq.(1.23).

$$\frac{{dC}_{HPG}}{dt} + {C}_{HPG} ( \frac{1}{{τ}_{GP}} + {k}_{2} + {k}_{m i} ( A / {V}_{GP} ) ( {H}_{1} ) ) = {{k}_{1} ( {C}_{OHG} )}^{2} \qquad ( 1.23 )$$

$$Ω = ( \frac{1}{{τ}_{GP}} + {k}_{2} + {k}_{m i} ( A / {V}_{GP} ) ( {H}_{1} ) )$$

Solving gives Eq.(1.24).

$${C}_{HPG} = {C}_{HPG}^{0} exp ( - Ω t ) + exp ( - Ω t ) {\int }_{0}^{t} exp ( Ω t ) {( {C}_{OHG} )}^{2} dt \qquad ( 1.24 )$$

If the initial concentration is zero and the ·H has reached a steady-state then H₂O₂ is given by Eq. (1.25).

$${C}_{HPG} = {{k}_{1} ( {C}_{OHG}^{ss} )}^{2} \frac{( 1 - exp ( - Ω t )}{Ω} \qquad ( 1.25 )$$

$${C}_{HPG}^{ss} = \frac{{k}_{1} {λ}_{1}^{2}}{Ω} \qquad ( 1.26 )$$

Therefore, H₂O₂ increases in the gas phase with a time constant of 1/Ω. The concentrations of H₂O₂ and ·OH in the liquid are determined from Eq.(1.27) and Eq.(1.28), respectively.

$$\frac{{dC}_{HPL}}{dt} + {C}_{HPL} {χ}_{1} = \frac{{k}_{m i} {AH}_{HPG}}{{V}_{L}} {C}_{HPG} \qquad ( 1.27 )$$

$${χ}_{1} = ( \frac{1}{{τ}_{L}} + {k}_{4} )$$

$$\frac{{dC}_{OHL}}{dt} + {C}_{OHL} {χ}_{2} = \frac{{k}_{m i} {AH}_{OHG}}{{V}_{L}} {C}_{OHG} \qquad ( 1.28 )$$

$${χ}_{2} = ( \frac{1}{{τ}_{L}} + {k}_{5} )$$

$${C}_{HPL} = {C}_{HPL}^{0} exp ( - {χ}_{1} t ) + exp ( - {χ}_{1} t ) {\int }_{0}^{t} exp ( {χ}_{1} t ) ( {C}_{HPG} ) ( \frac{{k}_{m i} {AH}_{HPG}}{{V}_{L}} ) dt \qquad ( 1.29 )$$

$${C}_{OHL} = {C}_{OHL}^{0} exp ( - {χ}_{2} t ) + exp ( - {χ}_{2} t ) {\int }_{0}^{t} exp ( {χ}_{2} t ) ( {C}_{OHG} ) ( \frac{{k}_{m i} {AH}_{OHG}}{{V}_{L}} ) dt \qquad ( 1.3 )$$

The time scales for these two species in the liquids are of order 0.1 to 1 s (assuming bulk phase reactions) and the liquid residence time is of order 0.1 s (assuming 100 ms from the range reported). However, if the reactions are fast, k₄, k₅>>1/_{TL} then the time scale will be shorter to reach a steady-state solution. The steady-state solutions are

$${C}_{HPL}^{ss} = \frac{( \frac{{k}_{m i} {AH}_{1 G}}{{V}_{L}} )}{{χ}_{1}} \frac{{k}_{1} {λ}_{1}^{2}}{Ω} \qquad ( 1.31 )$$

$${C}_{OHL}^{ss} = \frac{( \frac{{k}_{m i} {AH}_{2 G}}{{V}_{L}} )}{{χ}_{2}} {λ}_{1}$$

These will decay to zero once the electron density in the gas goes to zero, i.e. kₑ=0.

FIG. 14 shows the behavior of H₂O₂ in the case with a burst mode (only two pulses shown for brevity). Within the inner burst, the H₂O₂ builds up in the liquid phase through transfer from the gas until eventually with enough bursts the concentration levels off due to the balance between formation and degradation. When the burst is complete, the time between bursts allows for a relaxation of the reactions such that degradation by plasma species of H₂O₂ in the liquid is complete. This minimizes the waste of energy in the degradation reactions and should improve efficiency.
Note: Solution to Eq.(1.17) is given Eq.(1.32) and simplifying give Eq.(1.21).

$$\frac{{dC}_{OHG}}{( {C}_{OHG} - {λ}_{1} ) ( {C}_{OHG} - {λ}_{2} )} = - dt \qquad ( 1.32 )$$

$$\frac{1}{( {λ}_{2} - {λ}_{1} )} ln ( \frac{{C}_{OHG} - {λ}_{1}}{{C}_{OHG} - {λ}_{2}} ) ( \frac{{C}_{OHG}^{0} - {λ}_{2}}{{C}_{OHG}^{0} - {λ}_{1}} ) = - t$$

$$( \frac{{C}_{OHG} - {λ}_{1}}{{C}_{OHG} - {λ}_{2}} ) ( \frac{{C}_{OHG}^{0} - {λ}_{2}}{{C}_{OHG}^{0} - {λ}_{1}} ) = exp ( - t ( {λ}_{2} - {λ}_{1} ) )$$

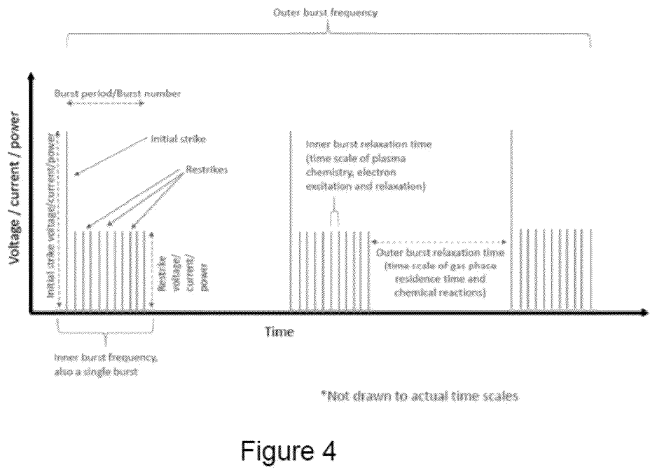

In addition to utilizing the shape and frequency of identical single pulses with regular spacing between pulses to enhance the efficiency of particular reactive chemical systems, bursts of pulses (FIG. 4) can be used enhance and affect the chemical reactions induced by the plasma. A burst of pulses means that a set of pulses, called a burst, can be repetitively modulated in sequences with variable spacing between pulses that differs from the spacing used in previous work where all pulses were separated by the same space. The timescale of the relaxation period between busts can be independently adjusted. The timescale of the relaxation period of pulses within a burst as well as the number of pulses in a burst can be independently adjusted. These parameters provide enhanced control of the system as compared to only manipulation of only single pule parameters. Variation of these parameters can be utilized to manipulate and control the plasma properties and system relaxation time independently in order to “tune” the system to enhance the efficiency of desired chemical processes.

The effects of changes in the mode of delivery of nanosecond pulses in a gas-liquid plasma reactor on the formation of hydrogen peroxide, H₂O₂, and, as an indicator for ·OH radicals, the decoloration of methylene blue, MB, were determined for pulse delivery by a) increasing frequency with uniform pulses (5-50 kHz), b) variation of the time between bursts of pulses (burst period), c) changing the inner burst frequency (1 over the time between the pulses in the burst), and d) variation of number of pulses in a burst (N-cycles). H₂O₂ peroxide formation was not affected by the method of pulse delivery in the range of parameters studied here and all data followed an approximately linear increase in H₂O₂ production rate with discharge power. In contrast, the MB decoloration rate was affected by the burst modes. In terms of discharge power, the MB decoloration rate was highest for the uniform pulse mode; however, the linear trend in increase of MB decoloration with power when the burst period was varied, suggest that at higher power the burst mode may be more effective than the uniform pulsing. Consideration of the per pulse decoloration with energy per pulse and with number of pulses suggest that the burst mode can affect reactions differently from applying a uniform pulse.

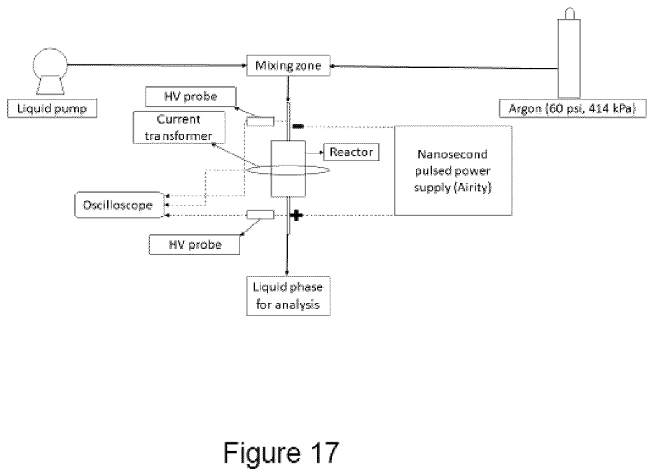

The experimental set-up used in this study is shown in FIG. 17. In all experiments the carrier gas was argon (60 psi). Deionized water with an initial pH of 6.04 and a conductivity of 14.1 μS/cm were utilized for the H₂O₂ production experiments. For the methylene blue (MB) decoloration experiments, 0.5 mM aqueous MB solutions were prepared from deionized water with a resulting pH of 6.2 and conductivity of 112 μS/cm. The liquid feed streams were supplied to the reactor using a high-pressure reciprocating pump (Optos Series, Eldex Laboratories, Napa, CA) and the flowrates used were 2 mL/min for all H₂O₂ experiments and 5-15 mL/min for the MB decoloration experiments. Before entering the reactor, the gas and the liquid streams enter a mixing zone and are then fed through a stainless-steel inlet capillary (0.25 mm ID) to the cylindrical reaction zone (4 mm height, 3 mm diameter). The reaction zone is located inside a quartz block of 2.5 cm×2.5 cm×1.3 cm as shown in FIG. 17. The liquid flows along the internal reactor walls and the gas flows through the central core while the plasma channel propagates along the gas-liquid interface. The gas-liquid mixture exits the reactor through a stainless-steel outlet capillary (1 mm ID). The inlet and outlet stainless steel capillary tubes act as electrodes through connections to the pulse forming network.

The nanosecond pulser of the pulse forming network was custom-made by Advanced Energy (Denver, CO). The power supply was connected to a function generator (Rigol 1022Z, Portland, OR), which provided 5V DC trigger signal and the pulse delivery with a pulse width of 96 ns. The function generator was also used to vary the uniform pulse frequency, outer burst frequency, inner burst frequency, and N-cycles.

A burst mode of the function generator was utilized to trigger the Airity pulser to send a train of high frequency bursts of pulses. The time between the bursts (burst period), the time between the pulses in the burst (internal frequency), and the number of pulses in a burst (N-cycles) were varied using the function generator. Inner burst relaxation time and outer burst relaxation time were varied by changing the internal frequency and burst period, respectively. An Illustration of burst mode voltage/current/power is shown in FIG. 4.

An electrical diagnostic method was used which would accommodate the burst mode operation. Two high voltage (HV) probes (TektronixP6015A, 1/1000; Beaverton, OR) were connected to the electrodes to measure the voltage difference between the electrodes (reactor inlet and outlet). A current monitor (Pearson Electronics, model 6585; Palo Alto, CA) was positioned around the body of the reactor to measure the current of the formed plasma channels. The voltage and the current probes were connected to an oscilloscope (Tekronix MCO 3014, Beaverton, OR) to determine the energy per burst via the following equation:

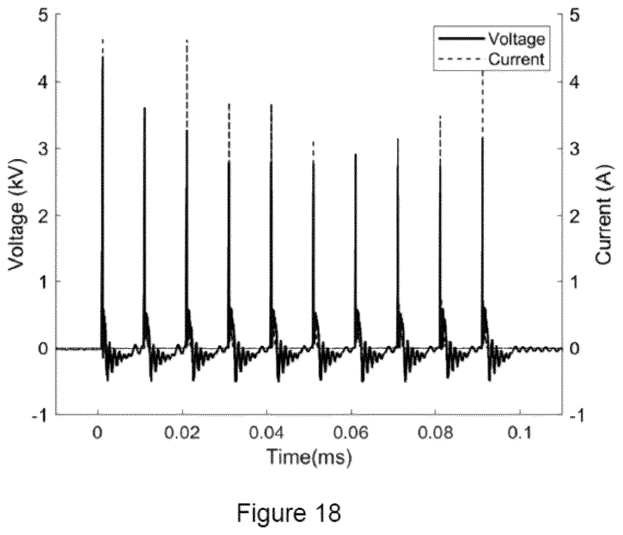

Energy per burst=∫(V×I)dt (Eq. 1)

where V is the instantaneous voltage, I is the instantaneous current, and t is the time period of the burst. FIG. 18 shows the V-I example waveform of one burst with a 100 kHz internal frequency, 1 ms burst period and 10 N-cycles. For each experimental condition, three high resolution measurements of one burst were obtained to calculate an average burst energy and associated error. Total power was then calculated by multiplying the average burst energy with the outer burst frequency.

The liquid effluent exiting the reactor was collected and analyzed to determine H₂O₂ concentration and MB decoloration for the various experiments conducted. A colorimetric test using titanium oxysulfate sulfuric acid complex and UV-Vis spectroscopy (Lambda 35, PerkinElmer, Waltham, MA) was used to determine H₂O₂ concentration. The MB concentration was also determined using UV-Vis spectroscopy from the absorbance band of the molecule at 664 nm. A calibration curve (see supplementary data) was prepared with serial dilution of a stock solution of 0.5 mM MB. Conductivity and pH were determined for all solutions using a conductivity probe (Cond 6+, Oakton Instruments, Vernon Hills, IL) and a pH probe (HACH, Loveland, Colorado); values for these measures data can be found in the supplementary data.

Three sets of experiments were conducted to determine the effect of burst mode on H₂O₂ formation as shown in Table 1.

TABLE 1
Burst mode parameters used for H₂O₂ experiments.

| | Internal | | |
|---|---|---|---|
| | frequency | | |
| Case # | (kHz) | Burst period (ms) | N-cycles |
| Burst mode, Case I | 100-400 | 1 | 5 |
| Burst mode, Case II | 100 | 0.1-1 | 5 |
| Burst mode, Case III | 100 | 1 | 1-40 |

The first burst mode, Case I, involves variation of the internal frequency between the individual pulse strikes from 100-400 kHz. The second burst mode, Case II, varies the burst period, i.e., the time between each burst from 0.1-1 ms. Case III varies the N-cycles, or the number of pulses in a burst from 1-40. Each set of experiments was conducted with a 2 mL/min DI water flowrate and a 45 V DC input voltage to the pulser, i.e., 5.1 kV of input voltage.

Four sets of experiments were conducted to determine the effects of burst mode on MB decoloration as shown in Table 2.

TABLE 2
Burst mode parameters used for MB decoloration experiments.

| | Internal | | |
|---|---|---|---|
| | frequency | | |
| Case # | (kHz) | Burst period (ms) | N-cycles |
| Uniform pulse | 5-50 | NA | NA |
| Burst mode, Case I | 50-300 | 0.5 | 10 |
| Burst mode, Case II | 100 | 0.25-1 | 10 |
| Burst mode, Case III | 100 | 1 | 1-30 |

The first is the uniform pulse case where the overall pulse frequency was varied from 5-50 kHz. The first burst mode, Case I, involves variation of the internal frequency between individual pulse strikes from 50-300 kHz. The second burst mode, Case II, varies the burst period, i.e., the time between each burst from 0.25-1 ms. Case III varies the N-cycles, or the number of pulses in a burst from 1-30. Each set of experiments was conducted for three different flowrates; 5 mL/min, 10 mL/min, and 15 mL/min. For all MB experiments a 50 V DC input voltage to the pulser was utilized i.e., 5.6 kV of input voltage.

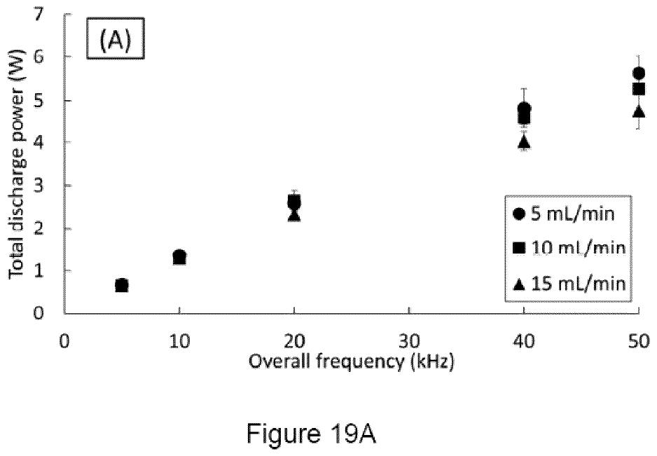

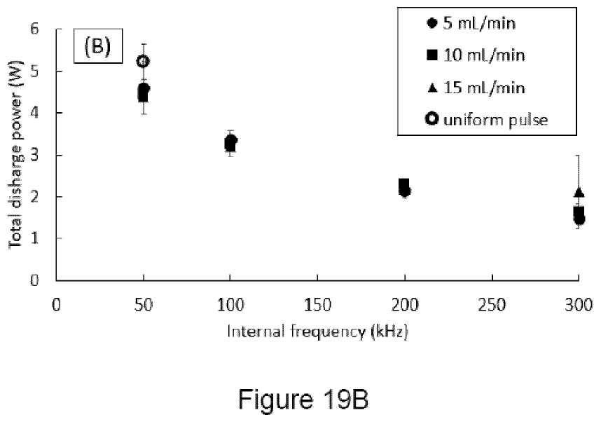

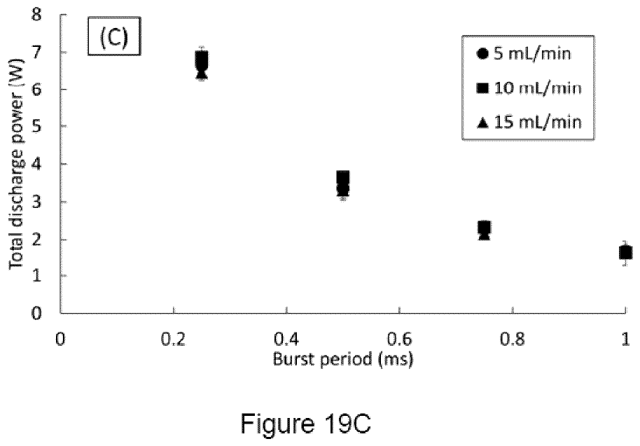

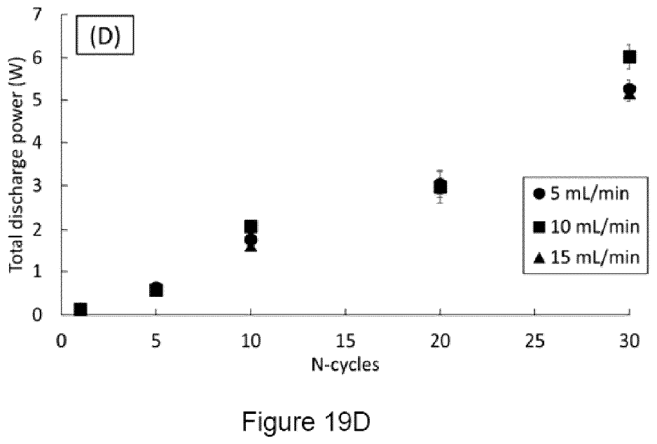

FIGS. 19A-D show the total discharge power for the different conditions for all cases. For the uniform pulsing, FIG. 19A, the total discharge power increased linearly with an increase in frequency from 5-50 kHz. In contrast, the power values decreased with an increase in the internal frequency for the Burst mode Case I, FIG. 19B, due to the “memory effect”, where there are charged particles (such as free electrons, positive ions, metastable species, etc.) remaining from the initial plasma strike which reduces the breakdown voltage required to initiate formation the next plasma channel (restrike). It should also be noted that the “restrikes” occur in the same spatial location in the reactor as the “initial strike”. The most energy is needed for the “initial strike” breakdown voltage to happen, after which, for successive restrikes, less total energy is needed as indicated by the reduced breakdown voltage and the current dissipated of each following restrikes. Therefore, the energy in each “restrike” is over an order of magnitude smaller than that of the “initial strike”, this results in lower power values as the internal frequency increases and this phenomenon is exacerbated. As the burst period increases, Case II, FIG. 19C, the overall burst frequency decreases. The total discharge power increased with an increase in the N-cycles, Case III, FIG. 19D, due to the increase in number of pulses in a burst. For all cases, it can be observed that the liquid flowrate does not have a significant effect on power. This is consistent with previous work because the increase in conductivity was minimal. i.e., 14.1 μS/cm to 112 μS/cm.

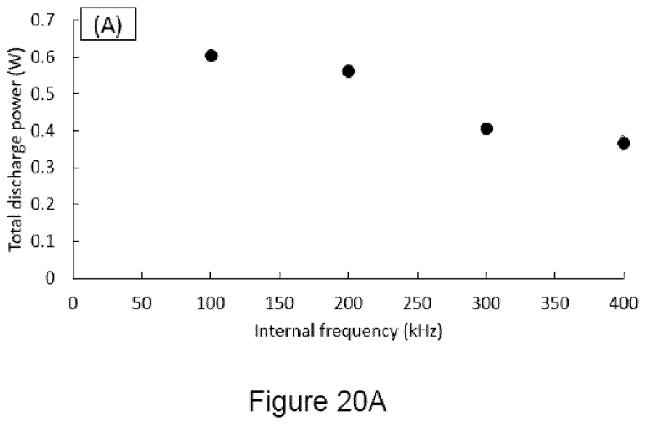

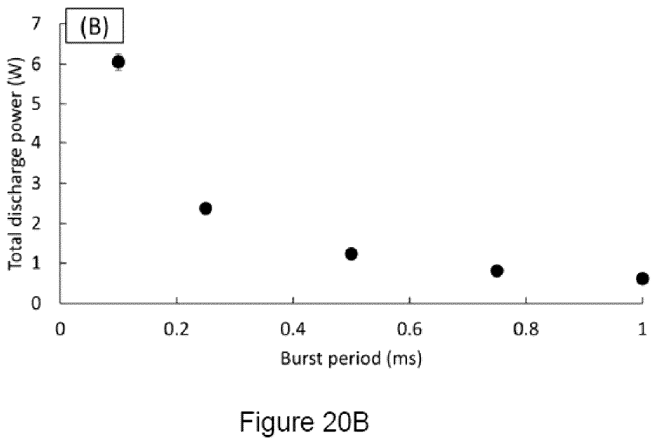

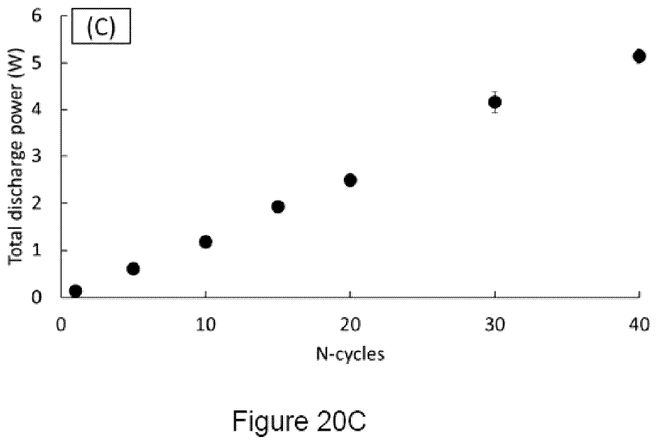

FIGS. 20A-C show the total discharge power as functions of the different burst mode variables for all burst mode cases for production of H₂O₂. As shown in FIG. 20A, the total discharge power decreases from 0.61 W to 0.37 W when the internal frequency was varied between 100 kHz-400 kHz at constant 1 ms burst period and 5 N-cycles. The reason for this decrease is explained by the memory effect. As the burst period increases, Case II, FIG. 20B, the overall burst frequency decreases. The total discharge power increased with an increase in the N-cycles, Case III, FIG. 20C, due to the increase in number of pulses in a burst. Power measurements for the H₂O₂ production experiments are shown in FIG. 20A-C. The DC input voltage used for the H₂O₂ study was 45 V i.e., 5.1 kV. This resulted in less total discharge power when compared with 50 V, i.e., 5.6 kV used for the MB testing.

H₂O₂ formation was found where there is a linear increase with single pulse frequency up to a specific value (approximately 10 kHz) and thereafter a leveling off of the production at higher frequency. The leveling off of production at higher frequency has been attributed to back reactions that lead to the degradation of H₂O₂ by radical reactions.

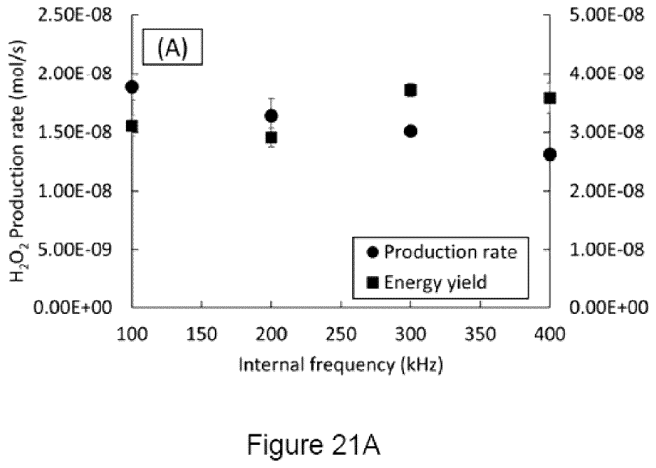

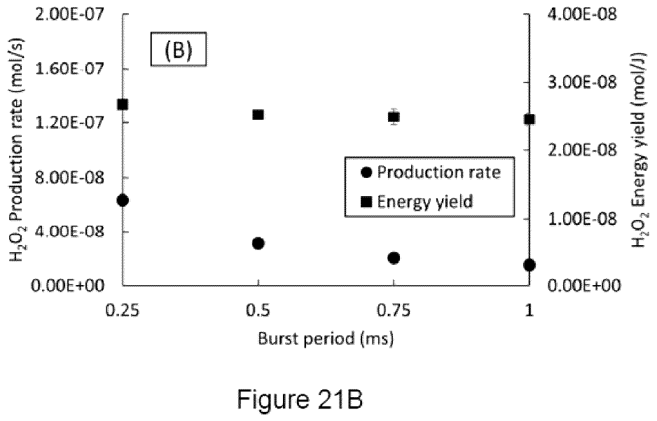

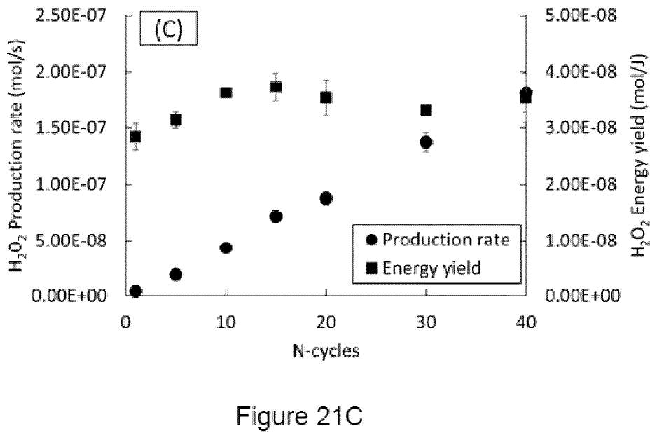

FIG. 21A-C show the H₂O₂ production rates and energy yields for the three burst mode cases. In Case I, FIG. 21A, the production rate and energy yield are not strong functions of the internal frequency although a maximum in energy yield is found at about 300 kHz. For Case II, FIG. 21B, the production rate decreases with burst period, which is consistent with the lower power, but the energy yield also drops. In Case III, FIG. 21C, the production rate increases linearly with the N-cycles. Due to a similar trend of power linearly increasing with N-cycles, the energy yield is approximately constant.

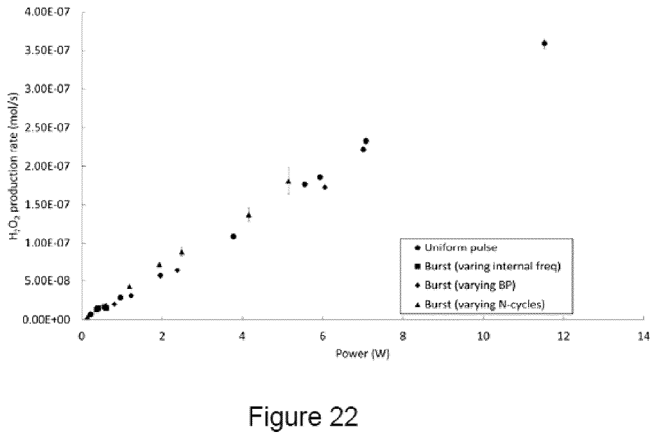

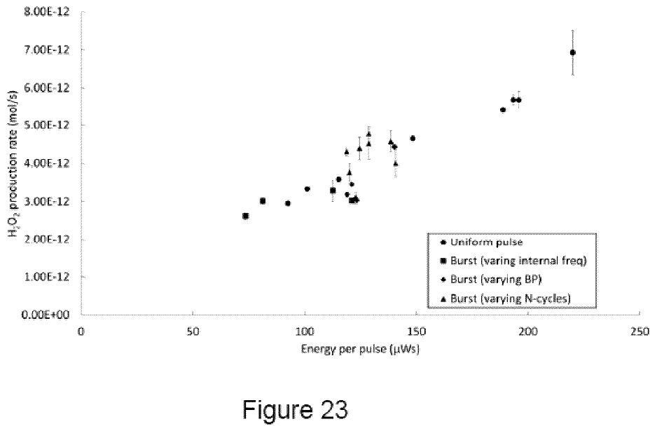

FIG. 22 shows the data for all cases in terms of the H₂O₂ production rate with total power. The uniform pulse data shown are from previous results. The burst mode results follow the same trend as the uniform pulse demonstrating that the implementation of the various types of bursts does not have a significant effect on the H₂O₂ production rate in the range investigated but does produce H₂O₂. Plotting the data on a per pulse basis against the energy per pulse as in FIG. 23 also demonstrates that H₂O₂ production in each pulse is correlated with the input energy in each pulse and not the means of how the pulse is delivered.

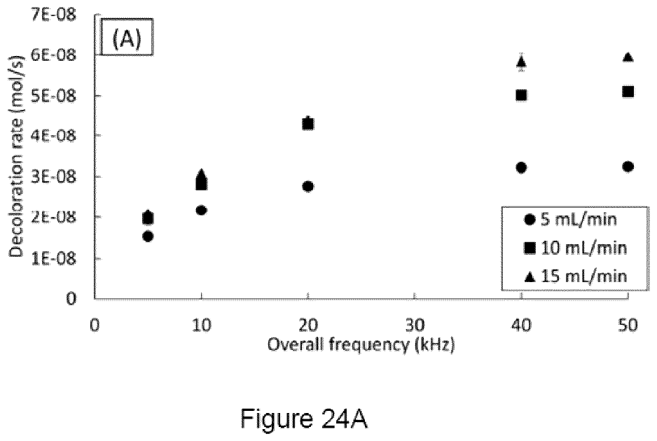

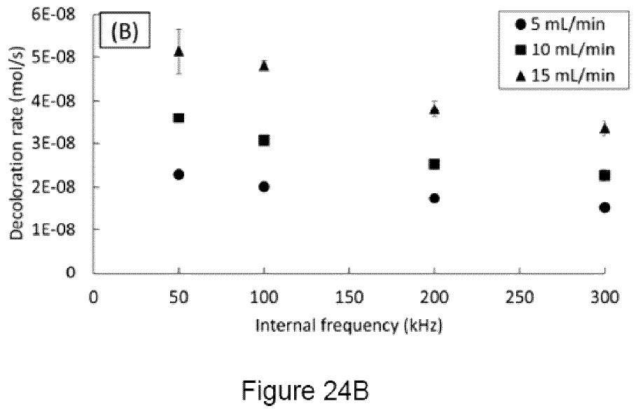

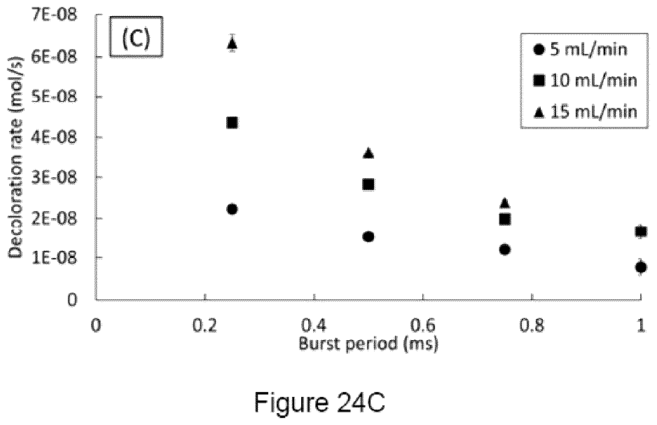

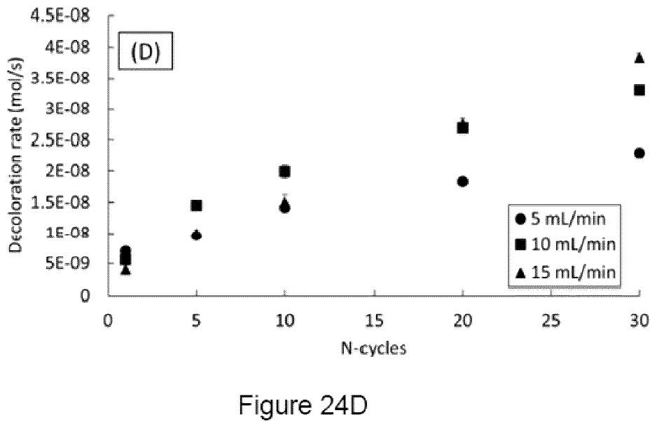

FIGS. 24A-D show the MB decoloration rates for all cases. The decoloration rate increases approximately linearly with frequency up to 10 kHz for 5 mL/min and 20 kHz for 10 and 15 mL/min. Thereafter it levels off to constant values at the frequencies above 40 kHz for the uniform pulsing case. The shifting of the frequency from the linear behavior to the saturation behavior at the higher liquid flow rates is consistent with the shorter liquid (and gas) residence times at higher flow rates and shorter inter-pulse periods at higher frequency. The smaller liquid residence time allows for higher production rate at higher frequencies minimizing back reactions that might reduce high reactive species.

In the burst mode cases, the decoloration rate decreased with an increase in the internal burst frequency, Case I, FIG. 24B, because the total discharge power decreased. Similarly, as for the uniform pulse case, when the solution flowrate was increased, the decoloration rate increased as well, since they are directly related. For Case II, FIG. 24C, the decoloration rate decreased with an increase in the burst period because the total discharge power and the overall frequency decreased with increasing burst periods. For Case III, FIG. 24D, the decoloration rate increased with an increase in N-cycles, as the number of pulses interacting with gas-liquid interface increased.

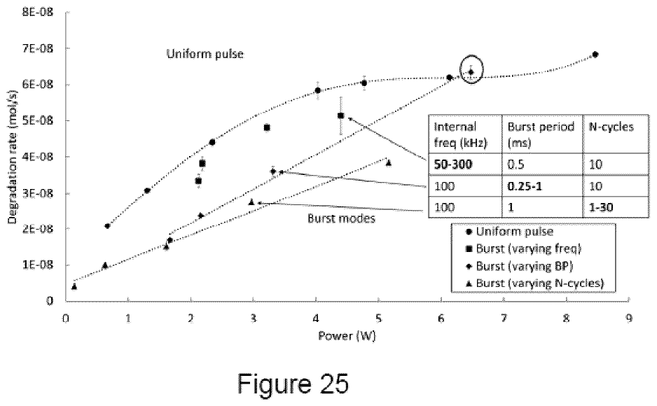

FIG. 25 shows the decoloration rate vs. power data for all the trials at the three flowrates. In contrast to the H₂O₂ results, the implementation of the burst mode affects the decoloration rate of MB. All cases showed an increase in the decoloration rate with an increase in the power, but the burst mode Case II and Case III have linear increases with power and the Case I and uniform pulsing show saturation type behavior at the higher power levels. The overall increase in decoloration with power is consistent with other plasma reactors where more power leads to higher decoloration or degradation. The linear increase in decoloration rate for the Case II and Case III suggests that when the gas residence time is of the same order of magnitude as the burst period, the linear increase with increasing power can be sustained, while in the uniform pulsing case where the gas residence time becomes much larger than the inter-pulse period, there is a saturation behavior.

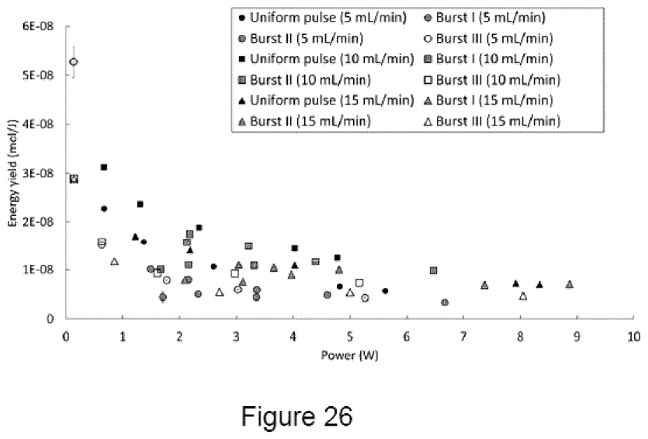

FIG. 26 shows the energy yield (EY) vs. power data for all the trials with the three flowrates. All trials showed an approximately exponentially decreasing trend in the energy yield values with an increase in the total discharge power. Generally, the highest EY values were achieved with the uniform pulse case. However, the burst mode, Case III, at low power with an N-cycle of 1, gave the highest overall energy yield but it should be noted that this case is equivalent to using a uniform pulse.

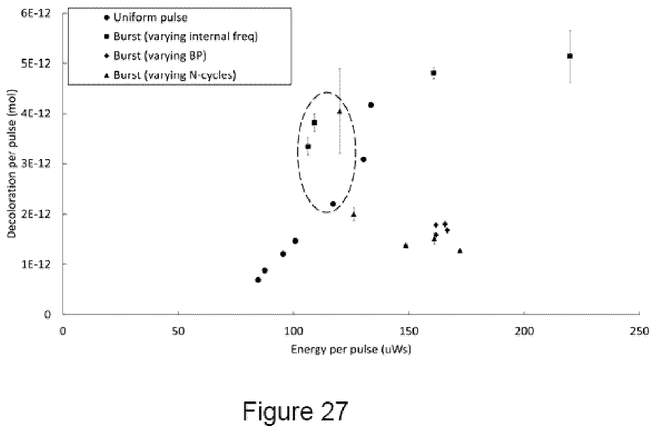

FIG. 27 shows the decoloration per pulse varying with energy per pulse at a 15 mL/min flowrate. The decoloration per pulse increases with energy per pulse for both uniform pulsing and Case I, variation of frequency. For Case II, the decoloration per pulse is almost constant with varying the bust period from 0.25-1 ms, however, the range of energy per pulse is very small. For Case III, varying N-cycles, the decoloration per pulse decreased with energy per pulse for N-cycles from 1-30. In the region indicated by a red circle, i.e., at the same energy per pulse, the burst modes can give higher decoloration rates compared with uniform pulse.

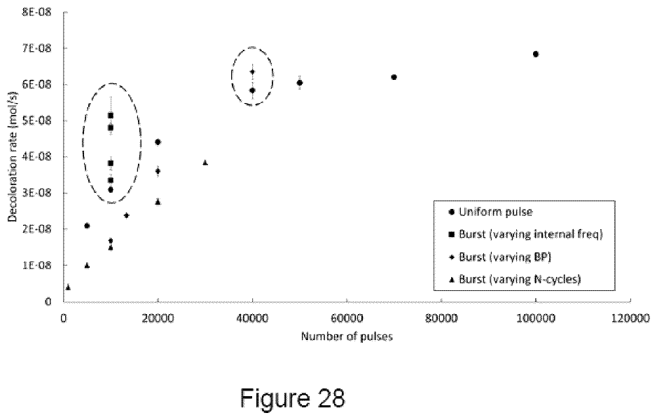

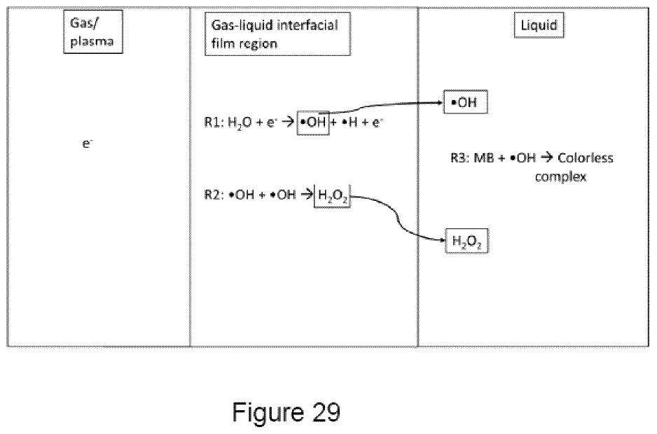

FIG. 28 shows the MB decoloration rate with variation of the total number of pulses. For uniform pulsing, the decoloration rate increased from 2.1×10⁻⁸ mol/s to 5.8×10⁻⁸ mol/s with an increase in total number of pulses from 5000-40000 and then increased from 5.8×10⁻⁸ mol/s to 6.8×10⁻⁸ mol/s when the total number of pulses increased from 40000-100000. For Case I, when the internal frequency was varied in the range of 50-300 kHz, the decoloration rate decreased from 5.1×10⁻⁸ mol/s to 3.4×10⁻⁸ mol/s at the fixed 10000 total number of pulses. For Case III, when the total number of pulses increased from 10000-40000, the decoloration rate increased from 1.7×10⁻⁸ mol/s to 6.4×10⁻⁸ mol/s. As shown in regions enclosed by red circles, several cases of the burst mode had higher decoloration rates than the uniform pulse with the same number of pulses.

Plasma propagates along the gas-liquid interface in our reactor. Water in contact with the plasma channel dissociates to form ·OH and ·H as shown in reaction R1. ·OH recombines to form H₂O₂(R2) at the gas-liquid interfacial film and dissolves rapidly into the liquid phase. ·OH dissolved into the liquid phase reacts with MB to form a colorless complex (R3). As noted, H₂O₂ was not affected by the pulse delivery method and linearly increased with total discharge power. MB decoloration was affected by the implementation burst mode and varying burst period resulted in higher decoloration than the uniform pulse. Table 3 shows Henry's law constant for H₂O₂ which is very high when compared with ·OH suggesting that H₂O₂ dissolves in liquid more easily than ·OH. It has been demonstrated that H₂O₂ was the predominate carrier of ·OH and the production of H₂O₂ was not affected by introduction of MB in the liquid phase. This suggests that the burst mode is affecting the ·OH that go into the liquid phase but not the ·OH that produce H₂O₂.

TABLE 3
Henry's law constants for H₂O₂ and •OH

| | Henry's law |
|---|---|
| Species | constant (M atm⁻¹) |
| H₂O₂ | 8.3 × 10⁴ |
| •OH | 25 |

The application of nanosecond pulses in sequences of bursts were found to affect MB decoloration but not H₂O₂ generation in a flowing gas-liquid plasma reactor. Variation of the inner burst frequency, burst period, and N-cycles, did not affect the H₂O₂ generation when compared to uniform pulsing and in all cases the data showed a linear increase in generation with discharge power. This result suggests that in the range of parameters studied, the change in times between pulses is not sufficient to affect the chemical reactions that lead to generation of H₂O₂. In contrast, MB decoloration was affected by implementation of the different modes of applying the pulses in bursts. In terms of discharge power, in general the decoloration rate of MB was higher in the uniform pulsing case except for variation of the burst period, which had the same production rate at 6 W of discharge power. The linearly increasing trend of decoloration rate with discharge power for the variation of the burst period suggests that higher discharge power may lead to further enhancement over the uniform pulse delivery mode. Further work is needed to achieve these higher powers. When considering the energy in a pulse, the decoloration rate per pulse with variation of the internal frequency can be higher than that with the uniform pulsing, thus suggesting the burst mode can affect chemical reactions in the liquid. This work suggests that utilization of power supplies with a larger range of parameters (including higher power) may enhance the role of the burst mode.

The systems and methods of the invention can be applied to a method of degrading per- and polyfluoroalkyl substances (PFAS) utilizing a gas/liquid/plasma reactor. The method includes the steps of:
providing a gas/liquid/plasma reactor;
providing a PFAS-containing liquid and a gas defining a gas/liquid interface within the gas/liquid/plasma reactor;
charging the PFAS-containing liquid and gas inside the gas/liquid/plasma reactor, the charging comprising the application of a voltage to electrodes and thereby to the PFAS-containing liquid and gas comprising a series of voltage bursts having an outer burst frequency, the voltage bursts each comprising a series of voltage pulses having an inner burst pulse frequency, the electrodes being oriented such that a plasma is propagated across the gas/liquid interface when the voltage pulses are applied.

The plasma discharge when used to degrade PFAS can have an outer burst frequency of from 100 Hz to 20 kHz, which corresponds to an outer burst period of from 0.05 to 10 ms. The plasma discharge for PFAS degradation can have an outer burst frequency of 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, or 20 kHz, and the outer burst frequency can be within a range of any high value to any low value selected from these values.

The plasma discharge when used to degrade PFAS can have an inner burst pulse frequency of from about 50 kHz to 2 MHz, which corresponds to an N cycle from 1 to 100. The plasma discharge for PFAS degradation can have an inner burst pulse frequence of 50, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1000, 1025, 1050, 1075, 1100, 1125, 1150, 1175, 1200, 1225, 1250, 1275, 1300, 1325, 1350, 1375, 1400, 1425, 1450, 1475, 1500, 1525, 1550, 1575, 1600, 1625, 1650, 1675, 1700, 1725, 1750, 1775, 1800, 1825, 1850, 1875, 1900, 1925, 1950, 1975 or 2000 kHz, and the inner burst pulse frequency can be within a range of any high value to any low value selected from these values.

The plasma discharge when used to degrade PFAS can have an outer burst period of 0.05 to 10 ms. The outer burst period for degrading PFAS can be 0.05, 0.075, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 3, 4, 5, 6, 7, 8, 9, 10 ms, and the outer burst period can have a range of any low value to any high value selected from these values.

When used for PFAS degradation, the plasma discharge can have a N cycle of from 1 to 100. The N cycle can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100, and can have a range of from any low value to any high value selected from these values.

The voltage applied to the electrodes for PFAS degradation can be from 1-50 kV. The voltage applied can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 kV, and can have a range of any low value to any high value selected from these values.

The PFAS that can be treated by the invention include perfluorobutanoic acid, perfluoropentanoic acid, perfluorohexanoic acid, perfluoroheptanoic acid, perfluorooctanoic acid, perfluorononanoic acid, perfluorodecanoic acid, perfluoroundecanoic acid, perfluorododecanoic acid, perfluorotridecanoic acid, perfluorotetradecanoic acid, perfluoropropyl sulfonic acid, perfluorobutane sulfonic acid, perfluoropentane sulfonic acid, perfluorohexane sulfonic acid, perfluoroheptane sulfonic acid, perfluorooctane sulfonic acid, perfluorononane sulfonic acid, perfluorodecane sulfonic acid, 2-(perfluorobutyl)-1-ethanesulfonic acid, 2-(perfluorohexyl)ethane-1-sulfonic acid, 2-(perfluorooctyl)ethane-1-sulfonic acid, perfluorobutylsulphonamide, perfluorohexanesulfonamide, perfluorooctanesulfonamide, N-methyl perfluorooctane sulfonamido acetic acid, N-ethyl perfluorooctane sulfonamido acetic acid, 4,8-dioxa-3H-perfluorononanoic acid, (Gen X) Hexafluoropropylene oxide dimer acid, tetrafluoroethanesulfonic acid, 9-chlorohexadecafluoro-3-oxanone-1-sulfonic acid, and 11-chloroeicosafluoro-3-oxaundecane-1-sulfonic acid. Other PFAS can be degraded by the methods of the invention.

The reactor for PFAS degradation can be the same as or different from the reactor described above. The liquid can include water. The liquid water can have a temperature of from greater than 0 to less than 100 degrees Celsius. The temperature of the liquid can be 0.1, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, or 99.9 degrees Celsius, or can have a range of any low value to any high value selected from these values.

The gas/liquid/plasma reactor can have a pressure for PFAS degradation of from approximately 0.1 to 4 bar. The pressure for PFAS degradation can be 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, or 4 bar, and can be within a range of any low value to any high value selected from these values.

The liquid water used for PFAS degradation can have a conductivity of near 1 microSiemens/cm to 50 milliSiemens/cm. The liquid water used for PFAS degradation can have a conductivity of 1, 2, 3, 4, 5, 6, 7, 8, 9, 10, 20, 30, 40, 50, 60, 70, 80, 90, 100, 150, 200, 250, 300, 350, 400, 450, 500, 550, 600, 650, 700, 750, 800, 850, 900, 950, or 1000 microSiemens/cm, or 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 milliSiemens/cm, and can have a range of conductivities of any low value to any high value selected from these values.

The method can include injecting the PFAS compound with the liquid and the gas, such that the PFAS compound will be reacted in the gas/liquid/plasma reactor. The gas can be air. The gas can be selected from the group consisting of a diatomic gas, a noble gas, and combinations thereof. The diatomic gas can be selected from the group consisting of hydrogen, nitrogen, oxygen, and combinations thereof. The noble gas can be selected from the group consisting of helium, neon, argon, krypton, xenon, radon, and combinations thereof.

A system for conducting PFAS degradation reactions can be similar to the gas/liquid/plasma reactor described above, comprising:
a gas/liquid/plasma reactor;
a source of PFAS-containing liquid and a gas defining a gas/liquid interface within the gas/liquid/plasma reactor; and
electrodes for charging the liquid and gas inside the gas/liquid/plasma reactor, and a voltage source for applying a voltage to the electrodes and thereby to the liquid and gas comprising a series of voltage bursts having a burst frequency, the bursts each comprising a series of voltage pulses having an inner burst pulse frequency, the electrodes being oriented such that a plasma is propagated across the gas/liquid interface when the voltage pulses are applied.

The gas/liquid/plasma reactor for PFAS degradation can comprise at least one inlet to the gas/liquid/plasma reactor, the inlet comprising an inlet electrode, wherein the liquid and the gas are charged inside the inlet by the inlet electrode; the inlet injecting the charged liquid and gas into the gas/liquid/plasma reactor, the injecting of the charged liquid and gas generating a continuously flowing liquid film region with the liquid on one or more internal walls of the gas/liquid/plasma reactor and with a gas stream of the gas flowing along the flowing liquid film region;
the injecting further propagating a plasma discharge channel pattern along the interface between the flowing liquid film region and the flowing gas stream inside the gas/liquid/plasma reactor; and,
an outlet comprising an outlet electrode.

The inlet electrode and the outlet electrode are electrically-conductive capillary tube electrodes. The electrically-conductive capillary inlet tube electrode has a first internal diameter, the gas/liquid/plasma reactor is tubular and has a second internal diameter, the electrically-conductive capillary outlet tube electrode has a third diameter, and wherein the third internal diameter is larger than the first internal diameter and smaller than the second internal diameter.

The defluorination rate of 50 ppm perfluorooctanoic acid (PFOA) has been analyzed as a function of pulse repetition frequency (1-10 kHz) and an optimum frequency of 5 kHz was observed. The effects of uniform pulse frequency and pulse width on time resolved electron density and electron temperature varying in a single pulse were found to directly correlate with the maximum defluorination rate of 50 ppm perfluorooctanoic acid (PFOA) in DI water with argon as carrier gas. The burst mode has demonstrated the potential for higher decoloration of methylene blue dye at higher power compared with uniform pulsing, while at lower power the uniform pulsing had a larger rate of decoloration than various modes of applying the bursts. The H₂O₂ production was linearly dependent upon discharge power and was not significantly affected by changing the pulse delivery with bursts.

Using the system shown in FIG. 17, a continuous gas-liquid flowing film reactor system was used to examine the degradation of perfluorinated alkyl substances (PFAS). Deionized (DI) water (pH—6.53, conductivity—13.5 μS/cm) and argon (Ar) were used as the liquid phase and carrier gas, respectively. The liquid phase was supplied at 2 mL/min for 50 ppm PFOA using a high-pressure reciprocating pump, and the carrier gas was supplied at 60 psig. The liquid and gas phases enter and exit the reactor through a stainless-steel capillary tube with 0.5 mm and 1 mm inner diameters, respectively. The liquid phase flows along the walls of the reactor, and the gas phase flows through the central core. The generated plasma channel propagates through the gas-liquid interface. The liquid and gas residence times at 2 mL/min liquid flow rate were estimated to be 150 ms and 0.3 ms. The stainless-steel capillary tubes also act as electrodes across which a custom-made nanosecond pulsed power supply manufactured by Advanced Energy (Denver, CO) was connected. The power supply was connected to a function generator (Rigol 1022Z, Portland, OR), which provided 5V DC trigger signal and the pulse delivery with a pulse width of 96 ns. The function generator was also used to vary the uniform pulse frequency and burst parameters used in this study.

Two different pulse delivery methods were used. The uniform pulse mode and uniform pulsing refers to an operating mode in which high voltage (HV) pulses are applied one at a time with a constant pulse repetition frequency. The time interval between successive pulses remains constant throughout the treatment period. The burst mode refers to a pulse delivery in which HV pulses are not applied continuously at a single uniform repetition rate but instead are grouped into a train of HV pulses with relaxation time between them, as shown in FIG. 4.

The uniform pulse frequency (f) was varied between 5-60 kHz for studying the defluorination of PFOA. Table 4 shows the burst parameters varied to study the plasma parameters and PFOA defluorination. The input voltage and pulse width used in this work were 10 kV and 96 ns, respectively.

TABLE 4
Burst parameters used

| | Outer Burst | | |
|---|---|---|---|
| | frequency | Inner burst | |
| | (kHz) | frquesncy (kHz) | N-cycles |
| Case I | 1 | 1000 | 1-40 (for PFOA) |
| Case II | 1 | 100-1000 | 10 |
| Case III | 1-10 | 1000 | 10 |

*Burst period (TBP) = 1/outer burst frequency

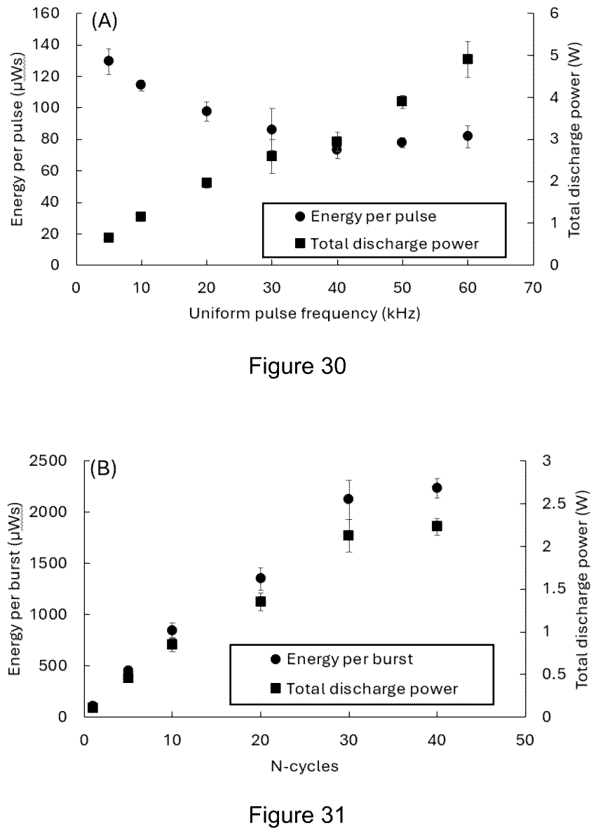

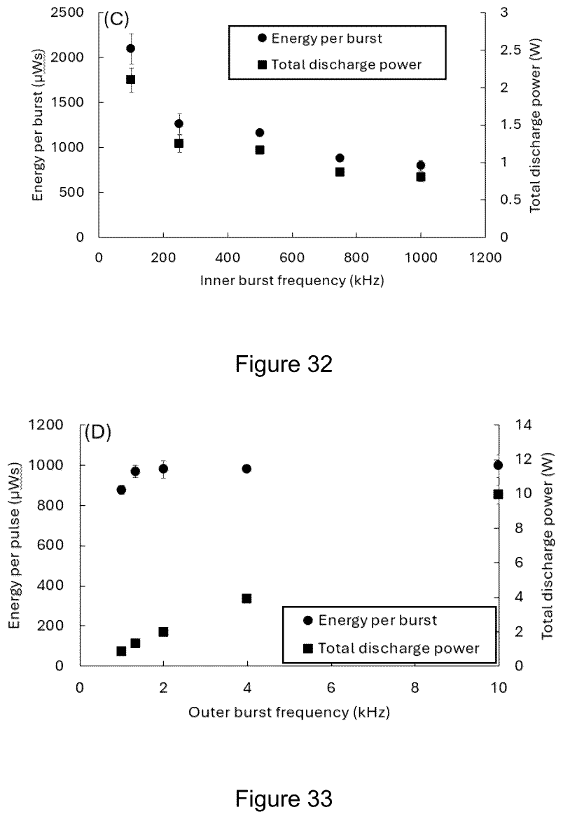

FIGS. 30-33 show the variation of energy per pulse (EPP) and total discharge power (P) while varying uniform pulse frequency and burst parameters. As shown in FIG. 30 EPP decreases from 129.4 μWs to 81.8 μWs when the uniform pulse frequency increases from 5 kHz to 60 kHz. P increased from 0.65 W to 4.91 W. As shown in FIG. 31, energy per burst (EPB) increased from 108.7 μWs to 2231.6 μWs when the N-cycles increased from 1 to 40 respectively while P increased from 0.11 W to 2.13 W. The decrease in EPB can be attributed to the increase in the number of pulses in a burst. As shown in FIG. 32, EPB decreases from 2098.7 μWs to 800.7 μWs and P decreases from 2.1 W to 0.8 W when the inner burst frequency was increased from 100 kHz to 1 MHz. The decrease in IF results in the decrease in τᵢₚ which results in memory effects where the breakdown is easier. The EPB remained constant while varying the outer burst frequency increased from 1 kHz to 4 kHz as shown in FIG. 33. However, EPB decreased from 970 μWs to 876.3 μWs when outer burst frequency increased from 4 kHz to 10 kHz. P increased from 0.99 W to 8.76 W. Since burst period (T_{BP}), T_{bp}<τ_{G} (0.3 ms), the decrease in EPB and EPB can be attributed to the memory effect as in the case of inner burst frequency.

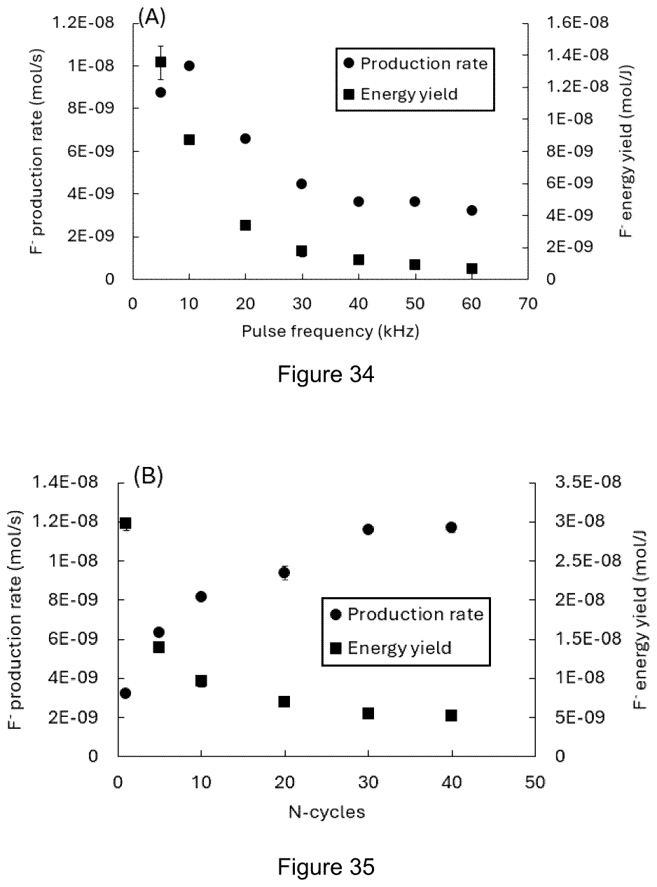

FIGS. 34-37 show the variation of fluoride production rate (N_{F}_{^{−}}) while varying uniform pulse frequency and the burst parameters. As shown in FIG. 34, N_{F}_{^{−}} increased from 8.73×10⁻⁹ mol/s to 9.97×10⁻⁹ mol/s when the uniform pulse frequency was increased from 5 kHz to 10 kHz and then decreased to 3.21×10⁻⁹ mol/s when the pulse frequency was increased from 10 kHz to 60 kHz. The F⁻ energy yield (EY_{F}_{^{−}}) decreased from 1.35×10⁻⁸ mol/J to 6.59×10⁻¹⁰ mol/J when the frequency was increased from 5 kHz to 60 kHz. The optimal 10 kHz uniform pulse frequency for N_{F}_{^{−}} can be attributed to the possible peak electron density in a single pulse while varying pulse frequency. The decrease in EY_{F}_{^{−}} is due to the increase in total discharge power.

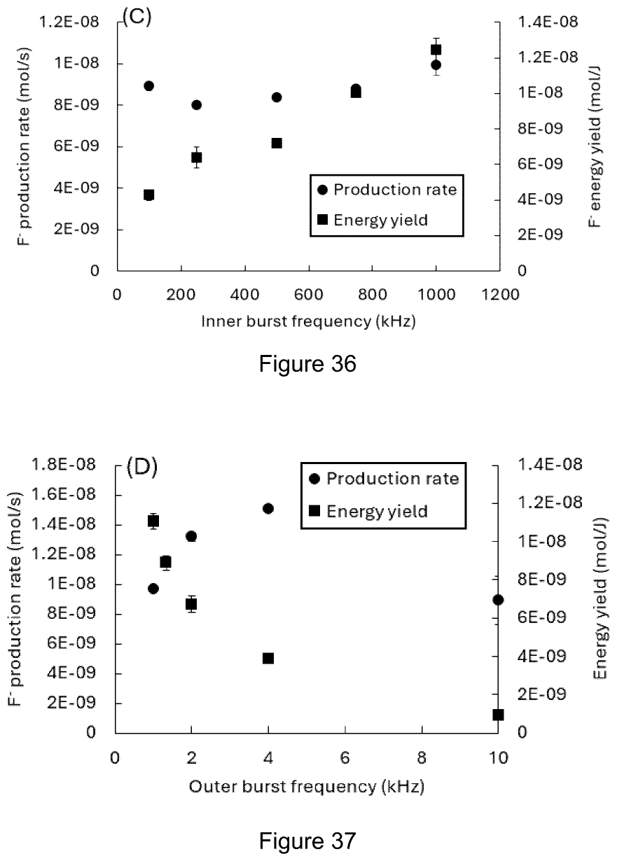

N_{F}_{^{−}} increased from 3.23×10⁻⁹ mol/s to 1.17×10⁻⁸ mol/s and EY_{F}_{^{−}} decreased from 2.97×10⁻⁸ mol/J to 5.24×10⁻⁹ mol/J when the N-cycles were increased from 1-40 as shown in FIG. 35. FIG. 36 shows that when inner burst frequency was increased from 100 kHz to 250 kHz, N_{F}_{^{−}} decreased from 8.89×10⁻⁹ mol/s to 7.98×10⁻⁹ mol/s and then increased to 9.93×10⁻⁹ mol/s when inner burst frequency was increased from 250 kHz to 1 MHz. EY_{F}_{^{−}} increased from 4.53×10⁻⁹ mol/J to 1.24×10⁻⁸ mol/J. The increase in EY_{F}_{^{−}} can be attributed to the decrease in P. As shown in FIG. 37, N_{F}_{^{−}} increased from 9.68×10⁻⁹ mol/s to 1.5×10⁻⁸ mol/s when outer burst frequency increased from 1 kHz to 4 kHz and then decreased to 8.92×10⁻⁹ mol/s from 4 kHz to 10 kHz. EY_{F}_{^{−}} decreased from 1.09×10⁻⁸ mol/J to 8.92×10⁻¹⁰ mol/J due to increase in P.

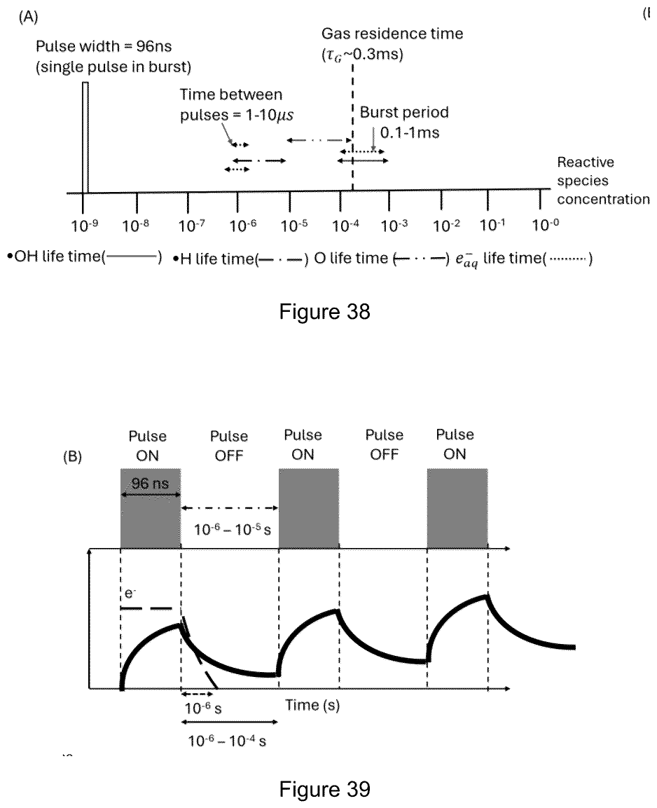

As shown in FIG. 38, the nanosecond pulse has a width of 96 ns. When the inner burst frequency was varied between 100 kHz to 1 MHz, τᵢₚ varied between 10 μs to 1 μs respectively. Outer burst frequency as discussed previously was varied between 1 kHz-10 kHz. The lifetime of ·OH varies between 0.1-1 ms and the lifetime of e_{aq}^{_} is short i.e., ~1 μs. The lifetime of ·H was estimated from the reaction ·H+·OH+M→H₂O+M (k=2.25×10⁻³¹ cm⁶/molecule²·s) and estimated to be in the order of magnitude of microseconds.

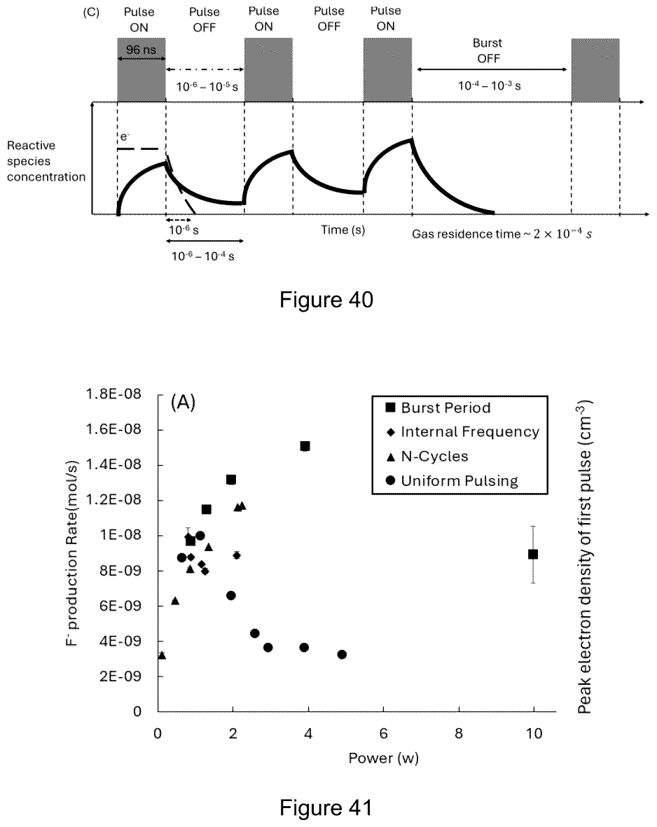

As shown in FIG. 39, when varying the N-cycles at 1 ms and 1 MHz, reactive species generated by the burst are flushed out because T_{BP}>τ_{G}. While varying N-cycles from 1-40, at 1 MHz, τᵢₚ could play an important role in accumulation of reductive species such as e_{aq}^{_}, ·H with increase in N-cycles, which resulted in increase in N_{F}_{^{−}}. Similarly, when varying inner burst frequency between 100 kHz to 1 MHz, τᵢₚ decreased from 10 μs to 1 μs, as observed in Huang et al.[44], e_{aq}^{_}, ·H accumulate and could result in an increase of N_{F}_{^{−}} with increase in inner burst frequency. When varying the outer burst frequency between 1 kHz-10 kHz, when outer burst frequency decreases from 10 kHz to 4 kHz the bursts interact with the gas phase continuously and will be flushed out completely, which could result in accumulation of reactive species as shown in FIG. 40. At 10 kHz outer burst frequency, T_{BP}<τ_{G}, the reactive species production decreases due to excessive overlap of bursts in the gas phase.

The common property measured between uniform pulsing and burst mode is the total discharge power. In the decoloration of methylene blue dye while varying burst parameters it was observed that uniform pulsing resulted in higher decoloration up to 5 W where variation of the outer burst frequency (1/burst period) resulted in same decoloration rate. ·OH in the liquid phase results in the decoloration of methylene blue while the reaction mechanism for PFOA defluorination is different. PFOA is a surfactant and high energy plasma electrons could be the species participating in weakening the strong C—F bond.

FIG. 41 shows the N_{F}_{^{−}} for all the cases studied. It was observed that varying the outer burst frequency (burst period) resulted in higher defluorination of PFOA when compared to uniform pulsing. At 1.1 W at 10 kHz uniform pulsing and 1.3 W at 0.75 ms-10N-1 ms, N_{F}_{^{−}} was higher for burst mode while varying the outer burst frequency (1/burst period). This suggests that the inter-pulse period i.e., 0.1 ms for uniform pulsing at 10 kHz and 1 μs for 1 MHz with 10 pulses in the burst while varying outer burst frequency (1/burst period) played an important role in defluorination of PFOA. It was also observed that the optimum condition while varying outer burst frequency (burst period) was 4 kHz (T_{BP}=0.25 ms) (τ_{G}≈T_{BP}) with IF of 1 MHz (τᵢₚ=1 μs) and 10 N-cycles. It was also observed that with increase in N-cycles (>20) resulted in higher defluorination when compared with uniform pulsing. Higher N-cycles (>30) and higher inner burst frequency (>750 kHz) also resulted in higher N_{F}_{^{−}} when compared to uniform pulsing at lower powers (<2 W). Table 5 shows a comparison of the invention with reported values.

TABLE 5
Comparison of fluoride production rates and energy yields
with reported values

| Method | C₀ (ppm) | N_{F}⁻ (mol/s) | EY_{F}⁻ (mol/J) |
|---|---|---|---|
| DBD (air) | 20 | 1.5 ×10⁻⁷ | 4.3 × 10⁻¹⁰ |
| Falling film DBD | 8.28 | 2.5 × 10⁻⁸ | 2.7 × 10⁻¹⁰ |
| (air) | | | |
| Strip fountain | 75 | 1.8 × 10⁻⁷ | 4.2 × 10⁻⁹ |
| DBD (argon) | | | |
| Plasma-ozonation | 0.2 | 1.2 × 10⁻⁹ | 2 × 10⁻¹¹ |
| cascade reactor | | | |
| (argon) | | | |
| DBD (air) | 5 | 3.8 × 10⁻⁹ | 1.3 × 10⁻⁹ |
| DBD (air) | 10 | 5 × 10⁻⁸ | 8.4 × 10⁻¹⁰ |
| Piezoelectric | 10 | 3 × 10⁻⁸ | 6.3 × 10⁻¹⁰ |
| direct discharge | | | |
| system (air) | | | |
| This work, | 50 | 3.21 × 10⁻⁹- | 1.35 × 10⁻⁸- |
| uniform pulsing | | 9.97 × 10⁻⁹ | 6.59 × 10⁻¹⁰ |
| This work, burst | 50 | 3.23 × 10⁻⁹- | 2.97 × 10⁻⁸- |
| mode | | 1.25 × 10⁻⁹ | 1.01 × 10⁻⁹ |

PFOA was used as an example to study the effect of the pulse delivery method of uniform pulsing and burst mode. An optimum frequency of 10 kHz was observed while varying pulse frequency. It was observed that defluorination rate increased with increase in N-cycles and an optimum condition was observed while varying outer burst frequency of 4 kHz (burst period=0.25 ms (≈τ_{G})). The defluorination rate increased as the τᵢₚ decreased while increasing the inner burst frequency.

The invention as shown in the drawings and described in detail herein disclose arrangements of elements of particular construction and configuration for illustrating preferred embodiments of structure and method of operation of the present invention. It is to be understood however, that elements of different construction and configuration and other arrangements thereof, other than those illustrated and described may be employed in accordance with the spirit of the invention, and such changes, alternations and modifications as would occur to those skilled in the art are considered to be within the scope of this invention as broadly defined in the appended claims. In addition, it is to be understood that the phraseology and terminology employed herein are for the purpose of description and should not be regarded as limiting.

We claim:

1. A method of degrading per- and polyfluoroalkyl substances (PFAS) utilizing a gas/liquid/plasma reactor, comprising the steps of:
providing a gas/liquid/plasma reactor;
providing a PFAS-containing liquid and a gas defining a gas/liquid interface within the gas/liquid/plasma reactor;
charging the PFAS-containing liquid and gas inside the gas/liquid/plasma reactor, the charging comprising the application of a voltage to electrodes and thereby to the liquid and gas comprising a series of voltage bursts having an outer burst frequency, the voltage bursts each comprising a series of voltage pulses having an inner burst pulse frequency, the electrodes being oriented such that a plasma is propagated across the gas/liquid interface when the voltage pulses are applied.

2. The method according to claim 1, wherein the plasma discharge has an outer burst frequency of from 100 Hz to 20 kHz.

3. The method according to claim 1, wherein the plasma discharge has an inner burst pulse frequency of from about 50 kHz to 2 MHz.

4. The method of claim 1, wherein the plasma discharge has a burst period of 0.05 to 10 ms.

5. The method of claim 1, wherein the plasma discharge has a N cycle of from 1 to 100.

6. The method of claim 1, wherein the voltage applied to the electrodes is from 1-50 kV.

7. The method of claim 1, wherein the PFAS comprises at least one selected from the group consisting of perfluorobutanoic acid, perfluoropentanoic acid, perfluorohexanoic acid, perfluoroheptanoic acid, perfluorooctanoic acid, perfluorononanoic acid, perfluorodecanoic acid, perfluoroundecanoic acid, perfluorododecanoic acid, perfluorotridecanoic acid, perfluorotetradecanoic acid, perfluoropropyl sulfonic acid, perfluorobutane sulfonic acid, perfluoropentane sulfonic acid, perfluorohexane sulfonic acid, perfluoroheptane sulfonic acid, perfluorooctane sulfonic acid, perfluorononane sulfonic acid, perfluorodecane sulfonic acid, 2-(perfluorobutyl)-1-ethanesulfonic acid, 2-(perfluorohexyl)ethane-1-sulfonic acid, 2-(perfluorooctyl)ethane-1-sulfonic acid, perfluorobutylsulphonamide, perfluorohexanesulfonamide, perfluorooctanesulfonamide, N-methyl perfluorooctane sulfonamido acetic acid, N-ethyl perfluorooctane sulfonamido acetic acid, 4,8-dioxa-3H-perfluorononanoic acid, (Gen X) Hexafluoropropylene oxide dimer acid, tetrafluoroethanesulfonic acid, 9-chlorohexadecafluoro-3-oxanone-1-sulfonic acid, and 11-chloroeicosafluoro-3-oxaundecane-1-sulfonic acid.

8. The method of claim 1, comprising:
injecting a mixture comprising the PFAS-containing liquid and the gas into at least one inlet to the gas/liquid/plasma reactor, the inlet comprising an inlet electrode;
charging the liquid and the gas inside the inlet with the inlet electrode,
injecting the charged liquid and gas into the gas/liquid/plasma reactor, the injecting of the charged liquid and gas generating a continuously flowing liquid film region with the liquid on one or more internal walls of the gas/liquid/plasma reactor and with a gas stream of the gas flowing along the flowing liquid film region;
the injecting propagating a plasma discharge channel pattern along the interface between the flowing liquid film region and the flowing gas stream inside the gas/liquid/plasma reactor; and,
flowing the liquid, gas, and plasma to an outlet comprising an outlet electrode.

9. The method of claim 8, wherein the inlet electrode and the outlet electrode are electrically-conductive capillary tube electrodes.

10. The method of claim 9, wherein the electrically-conductive capillary inlet tube electrode has a first internal diameter, the gas/liquid/plasma reactor is tubular and has a second internal diameter, the electrically-conductive capillary outlet tube electrode has a third diameter, and wherein the third internal diameter is larger than the first internal diameter and smaller than the second internal diameter.

11. The method of claim 10, wherein the liquid is water, and further comprising the step of dissociating the liquid at the interface with the plasma discharge to form a plurality of dissociation products, and producing hydrogen and/or hydrogen peroxide from the plurality of dissociation products, and dissolving the hydrogen and/or hydrogen peroxide into the flowing liquid film region.

12. The method of claim 11, wherein flowing the liquid, gas, plasma, and hydrogen and/or hydrogen peroxide to the electrically conductive outlet capillary tube electrode further comprises the step of recovering at least a portion of the hydrogen and/or hydrogen peroxide from the electrically conductive outlet capillary tube electrode.

13. The method of claim 11, wherein the liquid water has a temperature of from greater than 0 to less than 100 degrees Celsius, and wherein the gas/liquid/plasma reactor has a pressure of from approximately 0.1 to 4 bar.

14. The method of claim 11, wherein the liquid water has a conductivity of near 1 microSiemens/cm to 50 milliSiemens/cm.

15. The method of claim 8, wherein the flowing liquid film region has an annular shape.

16. The method of claim 9, wherein the inlet and the outlet to the gas/liquid/plasma reactor comprise an electrically conductive material.

17. The method of claim 1, wherein the gas is air.

18. The method of claim 1, wherein the gas is one selected from the group consisting of a diatomic gas, a noble gas, and combinations thereof.

19. The method of claim 18, wherein the diatomic gas is selected from the group consisting of hydrogen, nitrogen, fluorine, oxygen, iodine, chlorine, bromine, and combinations thereof.

20. The method of claim 18, wherein the noble gas is selected from the group consisting of helium, neon, argon, krypton, xenon, radon, and combinations thereof.

21. The method according to claim 1, further comprising injecting the PFAS compound with the liquid and the gas, such that the PFAS compound will be reacted in the gas/liquid/plasma reactor.

22. A system for conducting per- and polyfluoroalkyl substances (PFAS) degradation reactions utilizing a gas/liquid/plasma reactor, comprising:
a gas/liquid/plasma reactor;
a source of a PFAS-containing liquid and a gas defining a gas/liquid interface within the gas/liquid/plasma reactor;
electrodes for charging the PFAS-containing liquid and gas inside the gas/liquid/plasma reactor, and a voltage source for applying a voltage to the electrodes and thereby to the liquid and gas comprising a series of voltage bursts having a burst frequency, the bursts each comprising a series of voltage pulses having an inner burst pulse frequency, the electrodes being oriented such that a plasma is propagated across the gas/liquid interface when the voltage pulses are applied.

23. The system of claim 22, wherein the plasma discharge has an outer burst frequency of from 100 Hz to 20 kHz.

24. The system of claim 22, wherein plasma discharge has an inner burst pulse frequency of from about 50 kHz to 2 MHz.

25. The system of claim 22, wherein the voltage applied to the electrodes is from 1 to 50 kV.

26. The system of claim 22, wherein the plasma discharge has a burst period of 0.05 to 10 ms.

27. The system of claim 22, wherein the plasma discharge has a N cycle of from 1 to 100.

28. The system of claim 22, wherein the gas/liquid/plasma reactor comprises at least one inlet to the gas/liquid/plasma reactor, the inlet comprising an inlet electrode, wherein the PFAS-containing liquid and the gas are charged inside the inlet by the inlet electrode; the inlet injecting the charged PFAS-containing liquid and gas into the gas/liquid/plasma reactor, the injecting of the charged PFAS-containing liquid and gas generating a continuously flowing liquid film region with the PFAS-containing liquid on one or more internal walls of the gas/liquid/plasma reactor and with a gas stream of the gas flowing along the flowing liquid film region;
the injecting further propagating a plasma discharge channel pattern along the interface between the flowing liquid film region and the flowing gas stream inside the gas/liquid/plasma reactor; and,
an outlet comprising an outlet electrode.

29. The system of claim 28, wherein the inlet electrode and the outlet electrode are electrically-conductive capillary tube electrodes.

30. The system of claim 29, wherein the electrically-conductive capillary inlet tube electrode has a first internal diameter, the gas/liquid/plasma reactor is tubular and has a second internal diameter, the electrically-conductive capillary outlet tube electrode has a third diameter, and wherein the third internal diameter is larger than the first internal diameter and smaller than the second internal diameter.
